(19) United States
(12) Patent Application Publication
(10) Pub. No.: US 2024/0037412 A1
(43) Pub. Date: Feb. 1, 2024

(54) NEURAL NETWORK GENERATION DEVICE, NEURAL NETWORK CONTROL METHOD, AND SOFTWARE GENERATION PROGRAM

(71) Applicant: LeapMind Inc., Tokyo (JP)

(72) Inventors: Junichi KANAI, Tokyo (JP); Chuta YAMAOKA, Tokyo (JP)

(21) Appl. No.: 18/249,316

(22) PCT Filed: Oct. 19, 2021
(86) PCT No.: PCT/JP2021/038530

§ 371 Date: Apr. 17, 2023

(30) Foreign Application Priority Data
Oct. 19, 2020 (JP) 2020-175606

(51) Int. Cl. G06N 3/10; G06N 3/0464; G06N 3/063

(52) U.S. Cl. CPC G06N 3/10; G06N 3/0464; G06N 3/063

(57) ABSTRACT

A neural network generation device that generates a neural network execution model for performing neural network operations, the neural network generation device including an execution model generation unit that generates the neural network execution model based on hardware information regarding hardware in which the neural network execution model is running and network information regarding the neural network, and a software generation unit that generates software for running neural network hardware obtained by installing the neural network model in the hardware.

### TECHNICAL FIELD

The present invention relates to a neural network generation device, a neural network control method, and a software generation program. The present application claims priority on Japanese Patent Application No. 2020-175606, filed on Oct. 19, 2020, the content of which is incorporated herein by reference.

### BACKGROUND ART

In recent years, convolutional neural networks (CNNs) have been used as models for image recognition and the like. Convolutional neural network have a multilayered structure with convolution layers and pooling layers, and require many operations such as convolution operations. Various operation techniques that accelerate operations by convolutional neural networks have been proposed (Patent Document 1, etc.).

### CITATION LIST

### Patent Documents

[Patent Document 1] JP2018-077829 A

### SUMMARY OF INVENTION

### Technical Problem

Meanwhile, image recognition or the like utilizing convolutional neural networks is also used in embedded devices such as IoT devices. The generation of circuits and models that perform operations associated with neural networks adapted to the hardware configurations of embedded devices is sought in order to efficiently run convolutional neural networks in embedded devices. Additionally, a control method for running these circuits and models with high efficiency and at high speed is also sought. Additionally, a software generation program that generates software for running these circuits and models with high efficiency and at high speed is also sought.

In consideration of the above-mentioned circumferences, the present invention has the purpose of providing a neural network generation device that generates circuits and models for performing operations associated with a neural network that can run with high efficiency and at high speed and that are embeddable in an embedded device such as an IoT device, a neural network control method that runs, with high efficiency and at high speed, circuits and models for performing operations associated with a neural network, and a software generation program that generates software for running, with high efficiency and at high speed, circuits and models for performing operations associated with a neural network.

### Solution to Problem

In order to solve the above-mentioned problems, the present invention proposes the features indicated below.

A neural network generation device according to a first embodiment of the present invention is a neural network generation device that generates a neural network execution model for performing neural network operations, the neural network generation device comprising an execution model generation unit that generates the neural network execution model based on hardware information regarding hardware in which the neural network execution model is running and network information regarding the neural network, and a software generation unit that generates software for running neural network hardware obtained by installing the neural network model in the hardware.

A neural network control method according to a second embodiment of the present invention is a method for controlling neural network hardware that performs neural network operations, the neural network control method making the neural network hardware perform the operations by partitioning the neural network.

A software generation program according to a third embodiment of the present invention is a program for generating software to control neural network hardware that performs neural network operations, the software generation program making a computer generate the software for making the neural network hardware perform the operations by partitioning the neural network.

### Advantageous Effects of Invention

The neural network generation device, the neural network control method, and the software program of the present invention are embeddable in art embedded device such as an IoT device, and can generate and control a neural network that can be made to nm with high performance.

### BRIEF DESCRIPTION OF DRAWING

FIG. 1 is a diagram illustrating a neural network generation device according to a first embodiment.

FIG. 2 is a diagram illustrating inputs to and outputs from an operation unit in the neural network generation device.

FIG. 3 is a diagram illustrating an example of a convolutional neural network.

FIG. 4 is a diagram for explaining a convolution operation performed by a convolution layer in the convolutional neural network.

FIG. 5 is a diagram illustrating an example of a neural network execution model.

FIG. 6 is a timing chart indicating an operating example of the neural network execution model.

FIG. 7 is a control flow chart of the neural network generation device.

FIG. 8 is an internal block diagram of a convolution operation circuit that is generated.

FIG. 9 is an internal block diagram of a multiplier in the convolution operation circuit.

FIG. 10 is an internal block diagram of a multiply-add operation unit in the multiplier.

FIG. 11 is an internal block diagram of an accumulator circuit in the convolution operation circuit.

FIG. 12 is an internal block diagram of an accumulator unit in the accumulator circuit.

FIG. 13 is a state transition diagram of a control circuit in the convolution operation circuit.

FIG. 14 is an internal block diagram of a generated quantization operation circuit.

FIG. 15 is an internal block diagram of a vector operation circuit and a quantization circuit in the quantization operation circuit.

FIG. 16 is a block diagram of an operation unit in the vector operation circuit,

FIG. 17 is an internal block diagram of a quantization unit in the quantization circuit.

FIG. 18 is an internal block diagram of a generated DMAC.

FIG. 19 is a diagram for explaining data partitioning and data expansion in the convolution operation.

FIG. 20 is a diagram for explaining a network partitioning step.

FIG. 21 is a diagram for explaining a network partitioning step.

FIG. 22 is a diagram for explaining a network petitioning step.

FIG. 23 is a diagram for explaining a network partitioning step.

FIG. 24 is a diagram illustrating a timing chart for neural network hardware to which a partitioned operation has been allocated.

FIG. 25 is a timing chart indicating another example of allocation to the neural network hardware.

### DESCRIPTION OF EMBODIMENTS

### First Embodiment

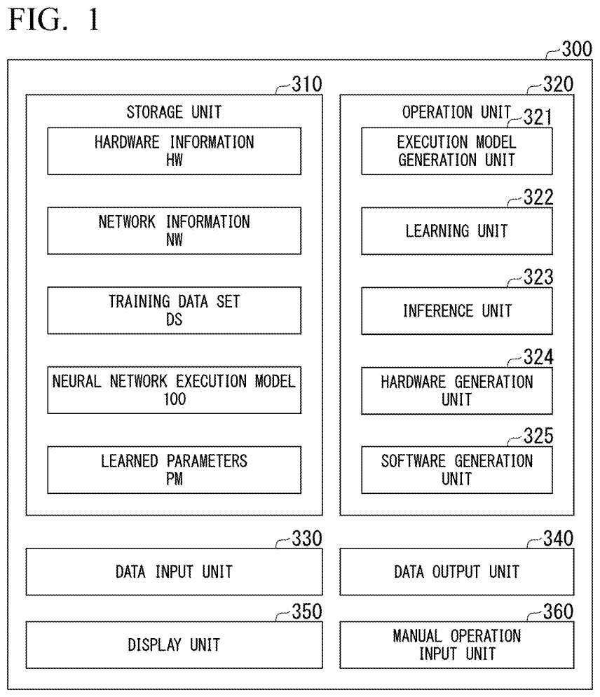

A first embodiment of the present invention will be explained with reference to FIG. 1 to FIG. 26.

FIG. 1 is a diagram illustrating a neural network generation device 300 according to the present embodiment.

### [Neural Network Generation Device 300]

The neural network generation device 300 is a device that generates a trained neural network execution model 100 that is embeddable in an embedded device such as an IoT device. The neural network execution model 100 is a software or hardware model generated for performing the operations of a convolutional neural network 200 (hereinafter referred to as “CNN 200”) in an embedded device.

The neural network generation device 300 is a program-executable device (computer) provided with a processor such as a CPU (Central Processing Unit) and hardware such as a memory. The functions of the neural network generation device 300 are realized by executing a neural network generation program and a software generation program in the neural network generation device 300. The neural network generation device 300 is provided with a storage unit 310, an operation unit 320, a data input unit 330, a data output unit 340, a display unit 350, and a manual operation input unit 360.

The storage unit 310 stores hardware information HW, network information NW, a training data set DS, a neural network execution model 100 (hereinafter referred to as an “NN execution model 100”) and learned parameters PM. The hardware information HW, the training data set DS, and the network information NW are input data that are input to the neural network generation device 300. The NN execution model 100 and the learned parameters PM are output data that am output by the neural network generation device 300. The “trained NN execution model 100” includes the NN execution model 100 and the learned parameters PM.

The hardware information HW is information regarding an embedded device in which the NN execution model 100 is to be run (hereinafter referred to as “operated hardware”). The hardware information HW is, for example, the device type of the operated hardware, a device constraint, a memory configuration, a bus configuration, an operating frequency, power consumption, a manufacturing process type, or the like. The device type is, for example, a type such as an ASIC (Application-Specific Integrated Circuit) or an FPGA (Field-Programmable Gate Array). The device constraint is the upper limit of the number of processor included in the operated device, the upper limit of the circuit size, or the like. The memory configuration is the memory type, the number of memory units, the memory capacity, or the input/output data width. The bus configuration is the bus type, the bus width, the bus communication standard, connected devices on the same bus, or the like. Additionally, in the case in which there are multiple variations of the NN execution model 100, the hardware information HW includes information regarding the variations of the NN execution model 100 to be used.

The network information NW is basic information regarding the CNN 200. The network information NW is, for example, the network configuration of the CNN 20), input data information, output data information, quantization information, or the like. The input data information is the input data type such as images or audio, the input data size, or the like.

The training data set DS includes training data D1 used for training and test data D2 used for inference tests.

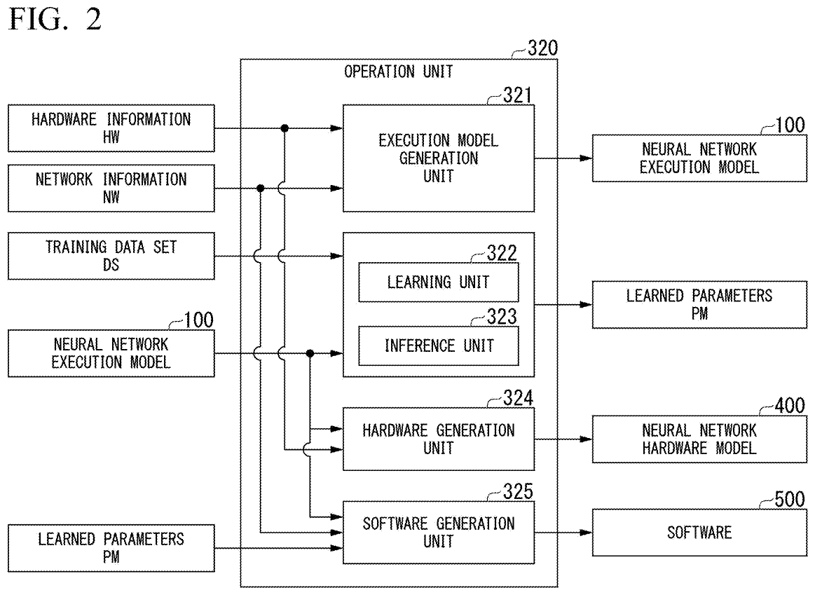

FIG. 2 is a diagram illustrating input to and output from the operation unit 320. The operation unit 320 has an execution model generation unit 321, a learning unit 322, an inference unit 323, a hardware generation unit 324, and a software generation unit 325. The NN execution model 100 input to the operation unit 320 may be generated by at device other than the neural network generation device 30.

The execution model generation unit 321 generates an NN execution model 100 based on the hardware information HW and the network information NW. The NN execution model 100 is a software or hardware model generated for making the CNN 200 perform operations in the operated hardware. The software includes software for controlling the hardware model. The hardware model may be at the behavior level, may be at the RTL (Register Transfer Level), may be a net list representing connections between gates and circuit modules, or may be a combination thereof.

The learning unit 322 uses the NN execution model 100 and the training data D1 to generate learned parameter PM. The inference unit 323 uses the NN execution model 100 and test data D2 to implement an inference test.

The hardware generation unit 324 generates a neural network hardware model 400 based on the hardware information HW and the NN execution model 100. The neural network hardware model 400 is a hardware model that can be installed in the operated hardware. The neural network hardware model 400 is optimized for the operated hardware based on the hardware information HW. The neural network hardware model 400 may be at the RTL (Register Transfer Level), may be a net list indicating connections between gates and circuit modules, or may be a combination thereof. The neural network hardware model 400 may be a parameter list or a configuration file necessary for installing the NN execution model 100 on the hardware. The parameter list or the configuration file is used in combination with the separately generated NN execution model 100.

In the description hereinafter, the neural network hardware model 400 installed on the operated hardware will be referred to as “neural network hardware 600”.

The software generation unit 325 generates software 500 for running the neural network hardware 600 based on the network information NW and the NN execution model 100. The software 500 includes software for transferring trained parameters PM to the neural network hardware 600 as needed.

Hardware information HW, network information NW, and the like necessary for generating the trained NN execution model 100 are input to the data input unit 330. The hardware information NW the network information NW, and the like are input, for example, as data written in a prescribed data format. The hardware information HW, the network information NW, and the like that have been input are stored in the storage unit 310. The hardware information HW, the network information NW, and the like may be input or changed by the user from the manual operation input unit 360.

A trained NN execution model 100 that has been generated is output to the data output unit 340. For example, the generated NN execution model 100 and learned parameters PM are output to the data output unit 340.

The display unit 350 has a known type of monitor such as an LCD display. The display unit 350 can display a console screen or the like for receiving GUI (Graphical User Interface) images, commands, or the like generated by the operation unit 320. Additionally, in the case in which the operation unit 320 requires information to be input by the user, the display unit 350 can display a message prompting the user to input information from the manual operation input unit 360, or a GUI image required for inputting information.

The manual operation input unit 360 is a device for the user to input instructions to the operation unit 320 or the like. The manual operation input unit 360 is a known type of input device such as a touch panel, a keyboard, or a mouse. The inputs to the manual operation input unit 360 are transmitted to the operation unit 320.

Some or all of the functions of the operation unit 320 are realized, for example, by one or more processors like a CPU (Central Processing Unit) or a GPU (Graphics Processing Unit) executing a program stored in a program memory. However, some or all of the functions of the operation unit 320 may be realized by hardware (e.g., circuitry) such as an LS (Large-Scale Integrated circuit), an ASIC Application-Specific Integrated Circuit), an FPGA (Field-Programmable Gate Array), or a PLD (Programmable Logic Device). Additionally, some or all of the functions of the operation unit 320 may be realized by combining software with hardware.

Some or all of the functions of the operation unit 320 may be realized by using a CPU or a GPU or an external accelerator such as hardware provided in an external device such as a cloud server. The operation speed of the operation unit 320 can be improved, for example, by using the operation unit 320 in conjunction with dedicated hardware or a GPU having high operation performance on a cloud server.

The storage unit 310 is realized by means of flash memory, an EEPROM (Electrically Erasable Programmable Read-Only Memory), a ROM (Read-Only Memory), a RAM (Random Access Memory), or the like. All or some of the storage twit 310 may be provided in an external device such as a cloud server, and may be connected to the operation unit 320 or the like by a communication line.

### [Convolutional Neural Network (CNN) 200]

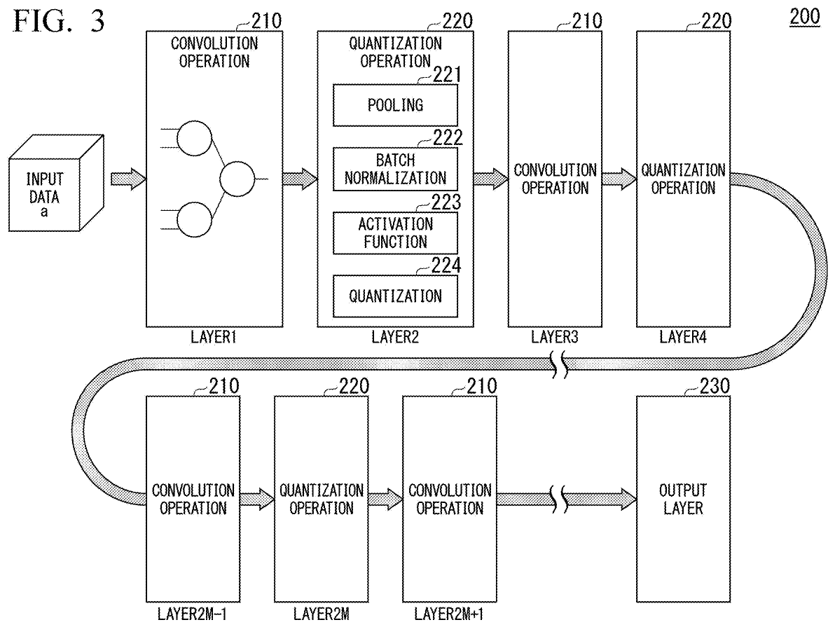

Next, the CNN 200 will be explained. FIG. 3 is a diagram illustrating an example of a CNN 200. The network information NW in the CNN 200 is information regarding the configuration of the CNN 200 explained below. The CNN 200 uses low-bit weights w and quantized input data a, and can easily be embedded in an embedded device.

The CNN 200 is a network having a multilayered structure, including convolution layers 210 that perform convolution operations, quantization operation layers 220 that perform quantization operations, and an output layer 230. In at least part of the CNN 200, the convolution layers 210 and the quantization operation layers 220 are connected in an alternating manner. The CNN 200 is a model that is widely used for image recognition and video recognition. The CNN 200 may further have a layer with another function, such as a fully connected layer.

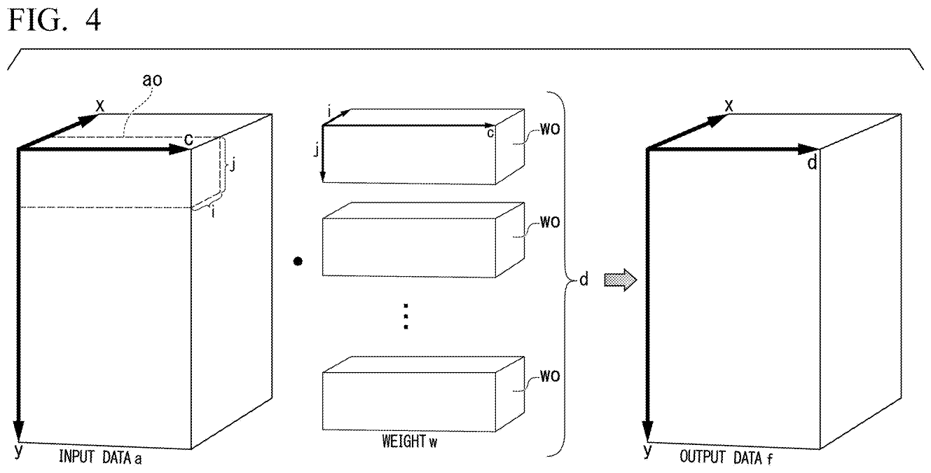

FIG. 4 is a diagram explaining the convolution operations performed by the convolution layers 210.

The convolution layers 210 perform convolution operations in which weight w are used on input data a. The convolution layers 210 perform multiply-add operations with the input data a and the weights w as inputs.

The input data a (also referred to as activation data or a feature map) that is input to the convolution layers 210 is multi-dimensional data such as image data. In the present embodiment, the input data a is a three-dimensional tensor comprising elements (x, y, c). The convolution layers 210 in the CNN 200 perform convolution operations on the low-bit input data a. In the present embodiment, the elements of the input data a are 2-bit unsigned integers (0, 1, 2, 3). The elements of the input data a may, for example, be 4-bit or 8-bit unsigned integers.

If the input data that is input to the CNN 200 is, in a format, e.g., of the 32-bit floating-point type, different from the format of the input data a input to the convolution layers 210, then the CNN 200 may further have an input layer for performing type conversion or quantization in front of the convolution layers 210.

The weights w (also referred to as filters or kernels) in the convolution layers 210 are multi-dimensional data having elements that are learnable parameters. In the present embodiment, the weights w are four-dimensional tensors comprising the elements (i, j, c, d). The weights h include d three-dimensional tensors (hereinafter referred to as “weights wo”) comprising the elements (i, j, c). The weights w in the trained CNN 200) are learned data. The convolution layers 210 in the CNN 200 use low-bit weights w to perform convolution operations. In the present embodiment, the elements of the weights w are 1-bit signed integers (0, 1), where the value “0” represents +1 and the value “1” represents −1.

The convolution layers 210 preform the convolution operation indicated in Equation 1 and output the output data f. In Equation 1, s indicates a stride. The region indicated by the dotted line in FIG. 4 represents one region ao (hereinafter referred to as “application region ao”) in which the weights wo are applied to the input data a. The elements of the application region ao can be represented by (x+i, y+j, c).

f(x,y,d)=Σ_{f}^{K}Σᵢ^{K}Σ_{c}^{C}a(s·x+i,s·y+j,c)·w(i,j,c,d) [Equation 1]

The quantization operation layers 220 implement quantization or the like on the convolution operation outputs that are output by the convolution layers 210. The quantization operation layers 220 each have a pooling layer 221, a hatch normalization layer 222, an activation function layer 223, and a quantization layer 224.

The pooling layer 221 implements operations such as average pooling (Equation 2) and max pooling (Equation 3) on the convolution operation output data f output by a convolution layer 210, thereby compressing the output data f from the convolution layer 210. In Equation 2 and Equation 3, u indicates an input tensor. v indicates an output tensor, and T indicates the size of a pooling region. In Equation 3, max is a function that outputs the maximum value of u for combinations of i and j contained in 7.

$$\begin{matrix}v ( x , y , c ) = \frac{1}{{r}^{2}} {\sum }_{i}^{T} {\sum }_{j}^{T} u ( T \cdot x + i , T \cdot y + j , c ) & [ Equation 2 ] \\ v ( x , y , c ) = max ( u ( T \cdot x + i , T \cdot y + j , c ) ) , i ∈ T , j ∈ T & [ Equation 3 ]\end{matrix}$$

The batch nominalization layer 222 normalizes the data distribution of the output data from a quantization operation layer 220 or a pooling layer 221 by means of an operation as indicated, for example, by Equation 4. In Equation 4, u indicates an input tensor, v indicates on output tensor, a indicates a scale, and β indicates a bias. In the trained CNN 200, α and α are learned constant vectors.

v(x,y,c)=α(c)·(u(x,y,c)−β(c)) [Equation 4]

The activation function layer 223 performs activation function operations such as ReLU (Equation 5) on the output from a quantization operation layer 220, a pooling layer 221, or a batch normalization layer 222. In Equation 5, a is an input tensor and v is an output tensor. In Equation 5, max is a function that outputs the argument having the highest numerical value.

v(x,y,c)=max(0,u(x,y,c)) [Equation 5]

The quantization layer 224 performs quantization as indicated, for example, by Equation 6, on the outputs from a pooling layer 221 or an activation function layer 223, based on quantization parameters. The quantization indicated by Equation 6 reduces the bits in the input tenor u to 2 bits. In Equation 6, q(c) is a quantization parameter vector. In the trained CNN 200, q(c) is a learned constant vector. In Equation 6, the inequality signs “≤” may be replaced with “<”.

qtz(x,y,c)=0 if u(x,y,c)≤q(c)·th0 else

1 if u(x,y,c)≤q(c)·th1 else

2 if u(x,y,c)≤q(c)·th2 else

3 [Equation 6]

The output layer 230 is a layer that outputs the results of the CNN 200 by means of an identity function, a softmax function, or the like. The layer preceding the output layer 230 may be either a convolution layer 210 or a quantization operation layer 220.

In the CNN 200, quantized output data front the quantization layers 224 are input to the convolution layer 210. Thus, the load of the convolution operations in the convolution layers 210 is smaller than that in other convolutional neural networks in which quantization is not performed.

### [Neural Network Execution Model 100 (NN Execution Model) 100]

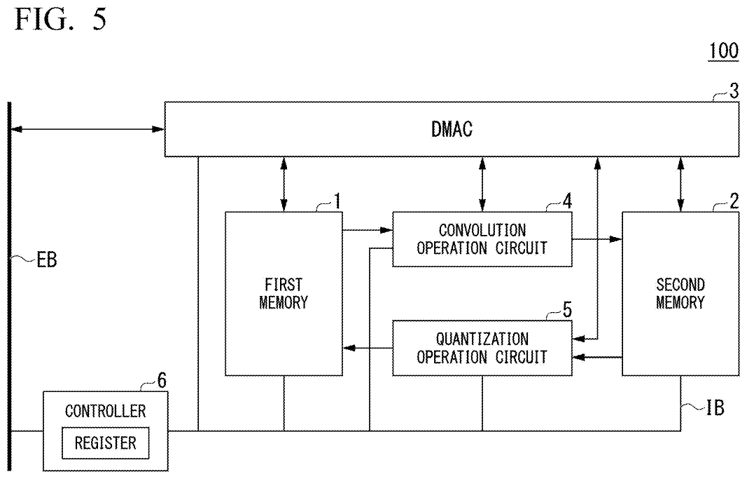

Next, the NN execution model 100 will be explained. FIG. 5 is a diagram illustrating an example of the NN execution model 100. The NN execution model 100 is a software or hardware model generated for making the CNN 200 perform operations in the operated hardware. Software includes software for controlling a hardware model. The hardware model may be at the behavior level, may be at the RTL (Register Transfer Level), may be a net list indicating connections between gates and circuit modules, or may be a combination thereof.

The NN execution model 100 is provided with a first memory 1, a second memory 2, a DMA controller 3 (hereinafter also referred to as “DMAC 3”), a convolution operation circuit 4, a quantization operation circuit 5, and a controller 6. The NN execution model 100 is characterized in that the convolution operation circuit 4 and the quantization operation circuit 5 form a loop with the first memory J and the second memory 2 therebetween.

The first memory 1 is a rewritable memory such as a volatile memory composed for example, of SRAM (Static RAM) or the like. Data is written into and read from the first memory 1 via the DMAC 3 and the controller 6. The first memory 1 is connected to an input port (if the convolution operation circuit 4, and the convolution operation circuit 4 can read data from the first memory 1. Additionally, the first memory 1 is connected to an output port of the quantization operation circuit 5, and the quantization operation circuit 5 can write data into the first memory 1. An external host CPU can input and output data with respect to the NN execution model 100 by writing and reading data with respect to the first memory 1.

The second memory 2 is a rewritable memory such as a volatile memory composed, for example, of SRAM (Static RAM) or the like. Data is written into and read from the second memory 2 via the DMAC 3 and the controller 6. The second memory 2 is connected to an input port of the quantization operation circuit 5, and the quantization operation circuit 5 can read data from the second memory 2. Additionally, the second memory 2 is connected to an output port of the convolution operation circuit 4, and the convolution operation circuit 4 can write data into the second memory 2. An external host CPU can input and output data with respect to the NN execution model 100 by writing and reading data with respect to the second memory 2.

The DMAC 3 is connected to an external bus EB and transfers data between an external memory, such as a DRAM, and the first memory 1. Additionally, the DMAC 3 transfers data between an external memory, such as a DRAM, and the second memory 2. Additionally, the DMAC 3 transfers data between an external memory, such as a DRAM, and the convolution operation circuit 4. Additionally, the DMAC 3 transfers data between an external memory, such as a DRAM, and the quantization operation circuit 5.

The convolution operation circuit 4 is a circuit that performs a convolution operation m a convolution layer 210 in the trained CNN 200. The convolution operation circuit 4 reads input data a stored in the first memory 1 and implements a convolution operation on the input data a. The convolution operation circuit 4 writes output data f (hereinafter also referred to as “convolution operation output data”) from the convolution operation into the second memory 2.

The quantization operation circuit 5 is a circuit that performs at least part of a quantization operation in a quantization operation layer 220 in the trained CNN 200. The quantization operation circuit 5 reads the output data f from the convolution operation stored in the second memory 2, and performs a quantization operation (among pooling, batch normalization, an activation function, and quantization, the operation including at least quantization) on the output data f from the convolution operation. The quantization operation circuit 5 writes the output data (hereinafter also referred to as “quantization operation output data”) out from the quantization operation into the first memory 1.

The controller 6 is connected to the external bus EB and operates as a slave to an external host CPU. The controller 6 has a register 61 including a parameter register and a state register. The parameter register is a register for controlling the operation of the NN execution model 100. The state register is a register indicating the state of the NN execution model 100, including semaphores S. The external host CPU can access the register 61 via the contoller 6.

The controller 6 is connected, via an internal bus IB, to the first memory 1, the second memory 2, the DMAC 3, the convolution operation circuit 4, and the quantization operation circuit 5. The external host CPU can access each block via the controller 6. For example, the external host CPU can issue commands to the DMAC 3, the convolution operation circuit 4, and the quantization operation circuit 5 via the controller 6. Additionally, the DMAC 3, the convolution operation circuit 4, and the quantization operation circuit 5 can update the state register (including the semaphores S) in the controller 6 via the internal bus 18. The state register including the semaphores S) may be configured to be updated via dedicated lines connected to the DMAC 3, the convolution operation circuit 4, or the quantization operation circuit 5.

Since the NN execution model 100 has a first memory 1, a second memory 2, and the like, the number of data transfers of redundant data can be reduced in the data transfers by the DMAC 3 from external memory such as a DRAM. As a result thereof, the power consumption due to memory access can be largely reduced.

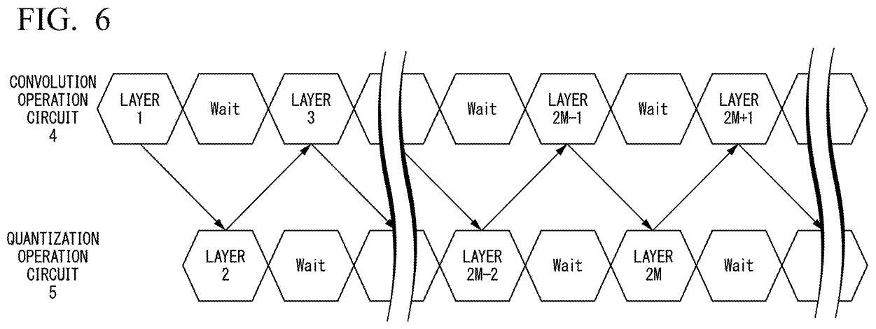

FIG. 6 is a timing chart indicating an operating example of the NN execution model 100. The NN execution model 100 performs operations of the CNN 200, which has a multilayered structure with multiple layers, by means of circuits forming loops. The NN execution model 100 can make efficient use of hardware resources due to the looped circuit configuration. Hereinafter, an operating example of the neural network hardware 600 indicated in FIG. 6 will be explained.

The DMAC 3 stores the input data a input to layer 1 (see FIG. 3) in the first memory 1. The DMAC 3 may transfer the input data a input to layer 1 after partitioning the data in accordance with the order of convolution operations performed by the convolution operation circuit 4.

The convolution operation circuit 4 reads out the input data a input to layer 1 (see FIG. 3) stored in the first memory 1. The convolution operation circuit 4 performs a layer-1 convolution operation on the input data a input to layer 1. The output data f from the layer-1 convolution operation is stored in the second memory 2.

The quantization operation circuit 5 reads the output data f from layer 1 stored in the second memory 2. The quantization operation circuit 5 performs a layer-2 quantization operation on the output data f from layer 1. The output data out from the layer-2 quantization operation is stored in the first memory 1.

The convolution operation circuit 4 reads the output data from the layer-2 quantization operation stored in the first memory 1. The convolution operation circuit 4 performs a layer-3 convolution operation using the output data our from the layer-2 quantization operation as the input data a. The output data f from the layer-3 convolution operation is stored in the second memory 2.

The convolution operation circuit 4 reads the output data our from a layer-(2M−2) (M being a natural number) quantization operation stored in the first memory 1. The convolution operation circuit 4 performs a layer-(2M−1) convolution operation using the output data our from the layer-(2M−2) quantization operation as the input data a. The output data f of the layer 42M−1) convolution operation is stored in the second memory 2.

The quantization operation circuit 5 reads the output data f from layer (2M−1) stored in the second memory 2. The quantization operation circuit 5 performs a layer-2M quantization operation on the output data f from layer (2M−1). The output data ow from the layer-2M quantization operation is stored in the first memory 1.

The convolution operation circuit 4 reads the output data out from the layer-2M quantization operation stored in the first memory 1. The convolution operation circuit 4 performs a laver-(2M+1) convolution operation using the output data out from the layer-2M quantization operation as the input data a. The output data f of the layer-(2M+1) convolution operation is stored in the second memory 2.

The convolution operation circuit 4 and the quantization operation circuit 5 perform operations in an alternating manner to carry out the operations of the CNN 200 indicated in FIG. 3. In the NN execution model 100, the convolution operation circuit 4 implements the layer-(2M−1) and layer 42M+1) convolution operations in a time-divided manner. Additionally, in the NN execution model 100, the quantization operation circuit 5 implements the layer 42M−2) and layer-2M quantization operations in a time-divided manner. For this reason, the NN execution model 100 has an extremely small circuit size in comparison with the case in which separate convolution operation circuits 4 and quantization operation circuits 5 are provided for each layer.

### [Operations of Neural Network Generation Device 300]

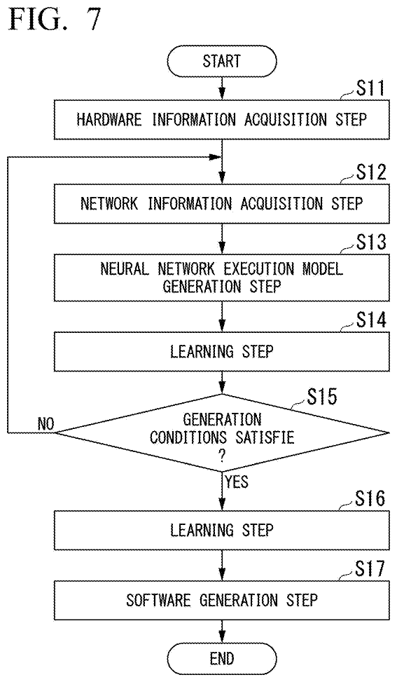

Next, the operations (neural network control method) of the neural network generation device 300 will be explained by following the control flow chart for the neural network generation device 300 indicated in FIG. 7. The neural network generation device 300 implements an initialization process (step S10), then executes step S11.

### <Hardware Information Acquisition Step (S11)>

In step S11, the neural network generation device 300 acquires hardware information HW for the operated hardware (hardware information acquisition step). The neural network generation device 300, for example, acquires hardware information HW input to the data input unit 330. The neural network generation device 300 may display a GUI image necessary for inputting the hardware information HW on the display unit 350, and may acquire the hardware information HW by having a user input the hardware information HW from the manual operation input unit 360.

The hardware information HW specifically includes a memory type, a memory capacity, and an input/output data width for memory allocated to the first memory 1 and the second memory 2.

The acquired hardware information HW is stored in the storage unit 310. Next, the neural network generation device 300 executes step S12.

### <Network Information Acquisition Step (S12)>

In step S12, the neural network generation device 300 acquires network information NW for the CNN 200 (network information acquisition step. The neural network generation device 300 acquires, for example, network information NW input to the data input unit 330. The neural network generation device 3X) may display a GUI image necessary for inputting the network information NW on the display unit 350, and may acquire the network information NW by having a user input the network information NW from the manual operation input unit 360.

The network information NW specifically includes the network configuration including the input layer and the output layer 230, the configuration of the convolution layers 210 including the bit widths of weights w and input data a, and the configuration of the quantization operation layers 220 including quantization information.

The acquired network information NW is stored in the storage unit 310. Next, the neural network generation device 300 executes step S13.

### <Neural Network Execution Model Generation Step (S13)>

In step S13, the execution model generation unit 321 in the neural network generation device 300 generates an NN execution model 100 based on the hardware information HW and the network information NW (neural network execution model generation step).

The neural network execution model generation step (NN execution model generation step) involves, for example, a convolution operation circuit generation step (S13-1), a quantization operation circuit generation step (S13-2), and a DMAC generation step (S3-3).

### <Convolution Operation Circuit Generation Step (S13-1)>

The execution model generation unit 321 generates the convolution operation circuit 4 of the NN execution model 100 hasted on the hardware information HW and the network information NW (convolution operation circuit generation step). The execution model generation unit 321 generates the hardware model of the convolution operation circuit 4 from information such as the bit widths of the weights w and the input data u that are input as network information NW. The hardware model may be at the behavior level, may be at the RTL (Register Transfer Level), may be a net list indicating connections between gates and circuit modules, or may be a combination thereof. Hereinafter, an example of a hardware model of the convolution operation circuit 4 that is generated will be explained.

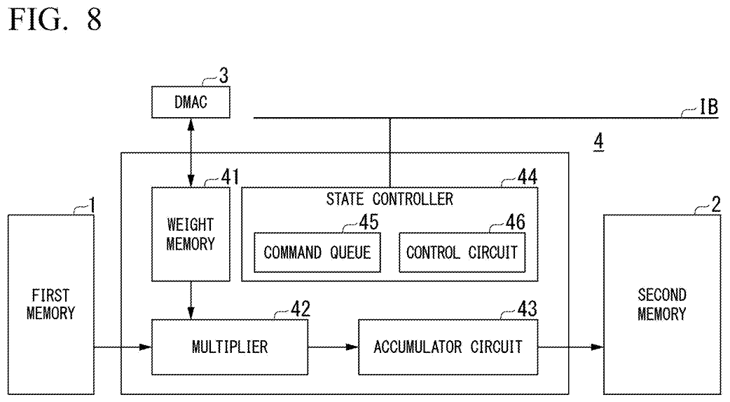

FIG. 8 is an internal block diagram of a generated convolution operation circuit 4.

The convolution operation circuit 4 has a weight memory 41, a multiplier 42, an accumulator circuit 43, and a state controller 44. The convolution operation circuit 4 has a state controller 44 that is dedicated to the multiplier 42 and the accumulator circuit 43 so that, when a command is input, a convolution operation can be implemented without requiring an external controller.

The weight memory 41 is a memory in which weights w used in convolution operations are stored, and may, for example, be a rewritable memory, such as a volatile memory composed of an SRAM (Static RAM) or the like. The DMAC 3 writes the weights w necessary for convolution operations into the weight memory 41 by means of DMA transfer.

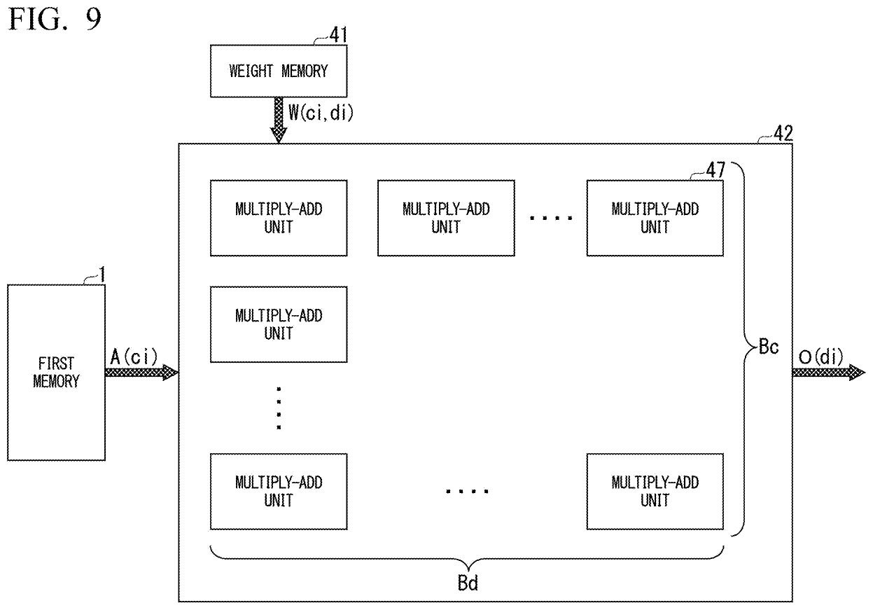

FIG. 9 is an internal block diagram of the multiplier 42.

The multiplier 42 multiplies the respective elements of the input vector a with the respective elements of the weight matrix w. The respective elements of the input vector a are data obtained by partitioning the input data a, and are vector data having Bc elements (for example, the “input vector A” described below). Additionally, the respective elements of the weight matrix w are data obtained by partitioning the weights w, and is matrix data having Bc×Bd elements (for example, the “weight matrix W” described below). The multiplier 42 have Bc×Bd multiply-add operation units 47 and can implement, in para-del, the multiplication of the input vector A with the weight matrix W.

The multiplier 42 implements the multiplication by reading out the input vector A and the weight matrix W necessary for the multiplication from the first memory 1 and the weight memory 41. The multiplier 42 outputs Bd multiply-add operation results O(di).

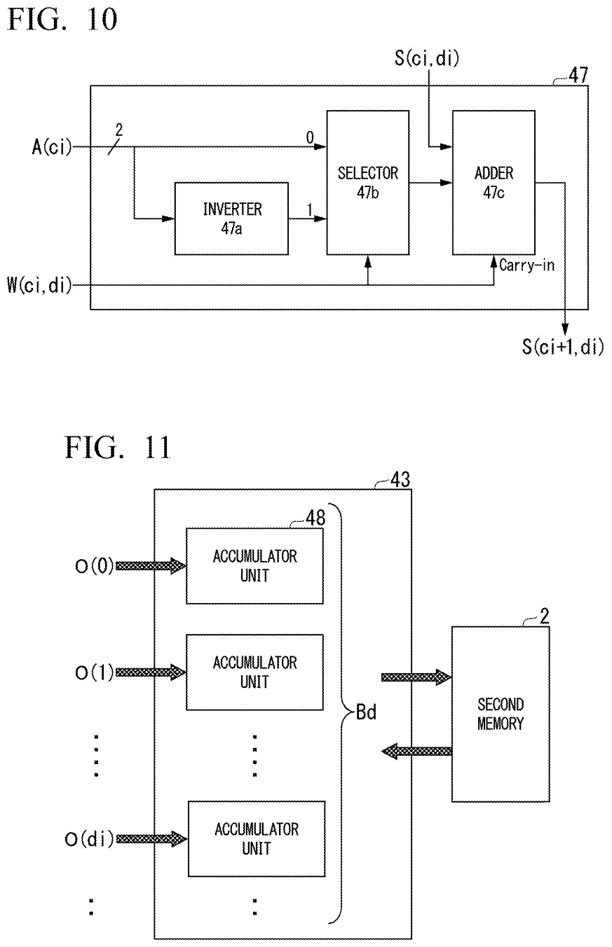

FIG. 10 is an internal block diagram of a multiply-add operation unit 47.

The multiply-add operation unit 47 implements multiplication between the element A(ci) of the input vector A and the elements W(ci, di) of the weight matrix W. Additionally, the multiply-add operation unit 47 adds the multiplication result to the multiplication results S(ci, di) from other multiply-add operation units 47. The multiply-add operation unit 47 outputs the addition result S(ci+1, di). The vi is an index from 0 to (Bc−1). The di is an index from 0 to (Bd−1). The elements A(ci) are 2-bit unsigned integers (0, 1, 2, 3). The elements W(ci, di) are 1-bit signed integers (0, 1), where the value “0” represents +1 and the value “1” represents −1.

The multiply-add operation unit 47 has an inverter 47a, a selector 47b, and an udder 47c. The multiply-add operation unit 47 performs multiplication using only the inverter 47a and the selector 47b, without using a multiplier. When the element W(ci, di) is “0”, the selector 47b selects to input the element A(ci). When the element W(ci, di) is “1”, the selector 47b selects a complement obtained by inverting the element A(ci) by means of the inverter. The element W(ci, di) is also input to Carry-in on the adder 47c. When the element W(ci, di) is “0” the adder 47c outputs a value obtained by adding the element A(ci) to S(ci, di). When W(ci, di) is “1”, the adder 47c outputs a value obtained by subtracting the element A(ci) from S(ci, di).

FIG. 11 is an internal block diagram of the accumulator circuit 43.

The accumulator circuit 43 accumulates, in the second memory 2, the multiply-add operation results O(di) from the multiplier 42. The accumulator circuit 43 has Bd accumulator units 48 and can accumulate Bd multiply-add operation results O(di) in the second memory 2 in parallel.

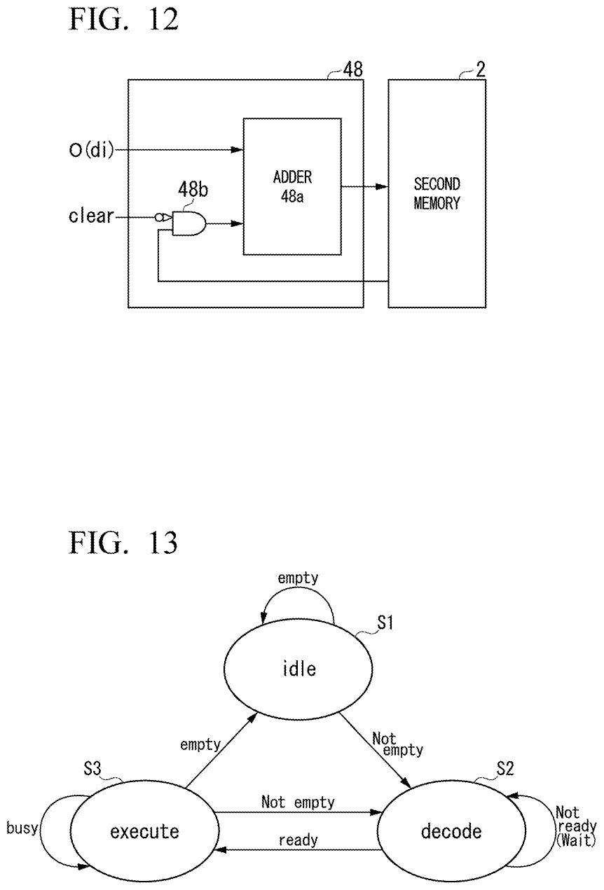

FIG. 12 is an internal block diagram of the accumulator unit 48.

The accumulator unit 48 has an adder 48a and a mask unit 48b. The adder 48a adds an element O(di) of the multiply-add operation results O to a partial sum that is obtained midway through the convolution operation indicated by Equation 1 stored in the second memory 2. The addition results have 16 bits per element. The addition results are not limited to having 16 bits per element, and for example, may have 15 bits or 17 bits per element.

The adder 48a writes the addition results at the same address in the second memory 2. Iran initialization signal “clear” is asserted, then the mask unit 48b masks the output from the second memory 2 and sets the value to be added to the element O(di) to zero. The initialization signal “clear” is asserted when the partial sum that is obtained midway is not stored in the second memory 2.

When the convolution operation by the multiplier 42 and the accumulator circuit 43 is completed, output data f(x, y, do) having Bd elements is stored in the second memory.

The state controller 44 controls the states of the multiplier 42 and the accumulator circuit 43. Additionally, the state controller 44 is connected to the contoller 6 via the internal bus IB. The slate controller 44 has a command queue 45 and a control circuit 46.

The command queue 45 is a queue in which commands C4 for the convolution operation circuit 4 are stored, and is constituted, for example, by an FIFO memory. Commands C4 are written into the command queue 45 via the internal bus 18.

The control circuit 46 is a state machine that decodes the commands C4 and that controls the multiplier 42 and the accumulator circuit 43 based on the commands C4. The control circuit 46 may be implemented by a logic circuit, or may be implemented by a CPU controlled by software.

FIG. 13 is a state transition diagram of the control circuit 46.

The control circuit 46 transitions from an idle state S1 to a decoding state S2 when a command C4 is input (Not empty) to the command queue 45.

In the decoding state S2, the control circuit 46 decodes a command C4 output from the command queue 45. Additionally, the control circuit 46 reads semaphores S stored in the register 61 in the controller 6, and determines whether or not operations can be executed in the multiplier 42 and the accumulator circuit 43 instructed by the command C4. If operations cannot be executed (Not ready), then the control circuit 46 waits (Wait) until the operation become executable. If the operations are executable (ready), then the control circuit 46 transitions from the decoding state S2 to an execution state S3.

In the execution state S3, the control circuit 46 controls the multiplier 42 and the accumulator circuit 43 to make the multiplier 42 and the accumulator circuit 43 execute the operations instructed by the command C4. When the operations in the multiplier 42 and the accumulator circuit 43 end, the control circuit 46 removes the command C4 that has been executed from the command queue 45 and updates the semaphores S stored in the register 61 in the controller 6. If there is a command in the command queue 45 (Not empty), then the control circuit 46 transitions front the execution state S3 to the decoding state S2. If there are no commands in the command queue 45 (empty), then the control circuit 46 transitions from the execution state S3 to the idle state S1.

The execution model generation unit 321 determines the specifications and the sizes (Bc and Bd) of the operation devices in the convolution operation circuit 4 from information such as the bit widths of the weights w and the input data u that are input as network information NW. In the case in which the hardware scale of the NN execution model 100 (neural network hardware model 400, neural network hardware 600) to be generated is included in the hardware information HW, the execution model generation unit 321 adjusts the specifications and the sizes (Bc and Bd) of the operation devices in the convolution operation circuit 4 in accordance with the designated scale.

### <Quantization Operation Circuit Generation Step (S13-2)>

The execution model generation unit 321 generates a quantization operation circuit 5 of the NN execution model 100 based on the hardware information HW and the network information NW (quantization operation circuit generation step). The execution model generation unit 321 generates a hardware model of the quantization operation circuit 5 from quantization information input as network information NW. The hardware model may be at the behavior level or may be at the RTL (Register Transfer level), may be a net list indicating connections between gates and circuit modules, or may be a combination thereof. Hereinafter, an example of a hardware model of the quantization operation circuit 5 that is generated will be explained.

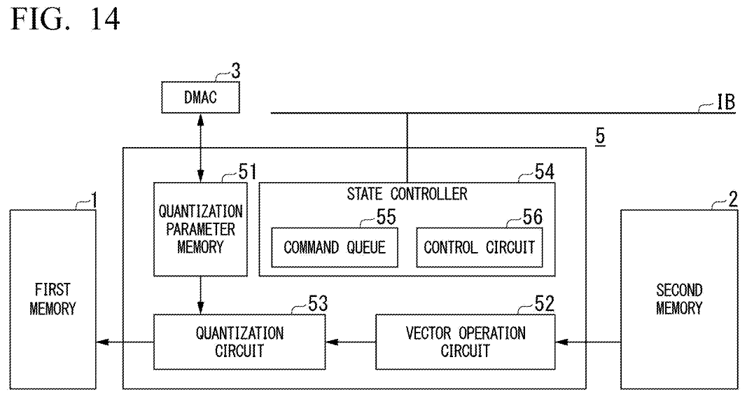

FIG. 14 is an internal block diagram of a generated quantization operation circuit 5.

The quantization operation circuit 5 has a quantization parameter memory 51, a vector operation circuit 52, a quantization circuit 53, and a state controller 54. The quantization operation circuit 5 has a state controller 54 that is dedicated to the vector operation circuit 52 and the quantization circuit 53 so that, when a command is input, a quantization operation can be implemented without requiring an external controller.

The quantization parameter memory 51 is a memory in which quantization parameters q used in quantization operations am stored, and may, for example, be a rewritable memory, such as a volatile memory composed of an SRAM (Static RAM) or the like. The DMAC 3 writes the quantization parameters q necessary for quantization operations into the quantization parameter memory 51 by means of DMA transfer.

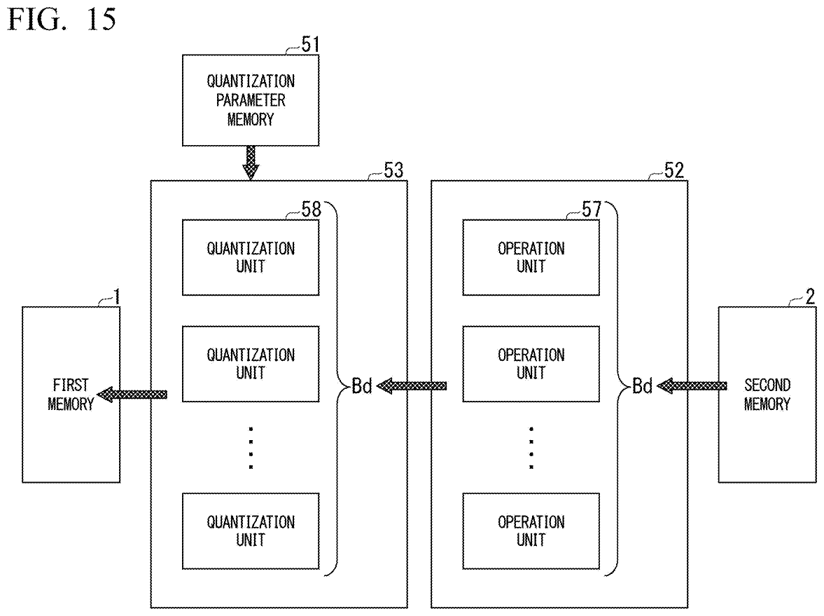

FIG. 15 is an internal block diagram of the vector operation circuit 52 and the quantization circuit 53.

The vector operation circuit 52 performs operations on the output data f(x, y, do) stored in the second memory 2. The vector operation circuit 52 has Bd operation units 57 and performs SIMD operations on the output data f(x, y, do) in parallel,

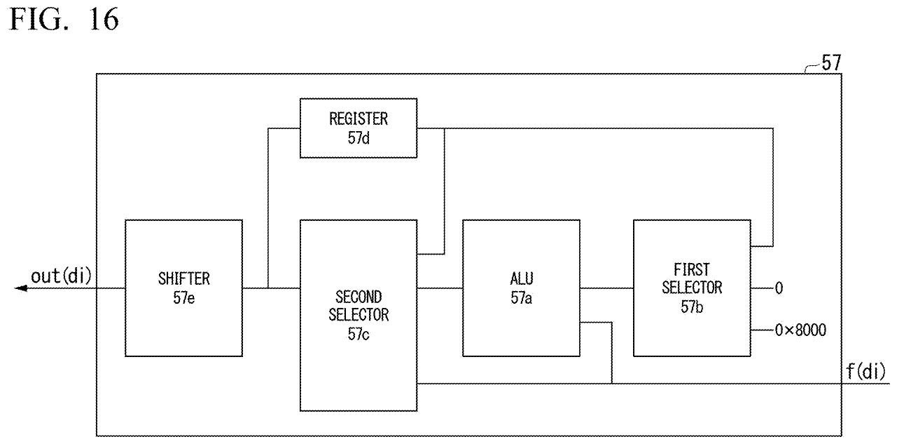

FIG. 16 is a block diagram of an operation unit 57.

The operation unit 57 has, for example, an ALU 57a, a first selector 57b, a second selector 57c, a register 57d, and a shifter 57e. The operation unit 57 may further have other operation devices or the like that are included in known general-purpose SIMD operation circuits.

The vector operation circuit 52 combines the operation devices and the like in the operation units 57, thereby performing, on the output data f(x, y, do), the operations of at least one of the pooling layer 221, the batch nominalization layer 222, or the activation function layer 223 in the quantization operation layer 220.

The operation unit 57 can use the A U 57a to add data stored in the register 57d to an element f(di) in the output data f(x, y, do) read from the second memory 2. The operation unit 57 can store the addition results from the ALU 57a in the register 57d. The operation unit 57 can initialize the addition results by using the first selector 57b to select a “0” as the value to be input to the ALU 57a instead of the data stored in the register 57d. For example, if the pooling region is 2×2, then the shifter 57e can output the average value of the addition results by shifting the output from the ALU 57a two bits to the right. The vector operation circuit 52 can implement the average pooling operation indicated by Equation 2 by having the Hd operation units 57 repeatedly perform the abovementioned operations and the like.

The operation unit 57 can use the ALU 57a to compare the data stored in the register 57d with an element f(di) in the output data f(x, y, do) read from the second memory 2. The operation unit 57 can control the second selector 57c in accordance with the comparison result from the ALU 57a, and can select the larger of the element f(di) and the data stored in the register 57d. The operation unit 57 can initialize the value to be compared so as to be the minimum value that the element f(di) may have by using the first selector 57h to select the minimum value as the value to be input to the ALU 57a. In the present embodiment, the element f(di) is a 16-bit signed integer, and thus, the minimum value that the element f(di) may have is “0x800”. The vector operation circuit 52 can implement the max pooling operation in Equation 3 by having the Bd operation units 57 repeatedly perform the abovementioned operations and the like. In the max pooling operation, the shifter 57e does not shift the output of the second selector 57c.

The operation unit 57 can use the ALU 37a to perform subtraction between the data stored in the register 57d and an element f(di) in the output data f(x, y, do) read from the second memory 2. The shifter 57e can shift the output of the ALU 57a to the let (i.e., multiplication) or to the right (i.e., division). The vector operation circuit 52 can implement the batch normalization operation in Equation 4 by having the Bd operation units 57 repeatedly perform the abovementioned operations and the like.

The operation unit 57 can use the ALU 57a to compare an element f(di) in the output data f(x, y, do) read from the second memory 2 with “0” selected by the first selector 57b. The operation unit 57 can, in accordance with the comparison result in the ALU 57a, select and output either the element f(di) or the constant value “0” prestored in the register 57d. The vector operation circuit 52 can implement the ReLU operation in Equation 5 by having the Bd operation units 57 repeatedly perform the abovementioned operators and the like.

The vector operation circuit 52 can implement average pooling, max pooling, batch normalization, and activation function operations, as well as combinations of these operations. The vector operation circuit 52 can implement general-purpose SIMD operations, and thus may implement other operations necessary for operation, in the quantization operation layer 220. Additionally, the vector operation circuit 52 may implement operations other than operations in the quantization operation layer 220.

The quantization operation circuit 5 need not have a vector operation circuit 52. If the quantization operation circuit 5 does not have a vector operation circuit 52, then the output data f(x, y, do) is input to the quantization circuit 53.

The quantization circuit 53 performs quantization of the output data from the vector operation circuit 52. The quantization circuit 53, as illustrated in FIG. 15, has Bd quantization units 58, and performs operations in the output data from the vector operation circuit 52 in parallel.

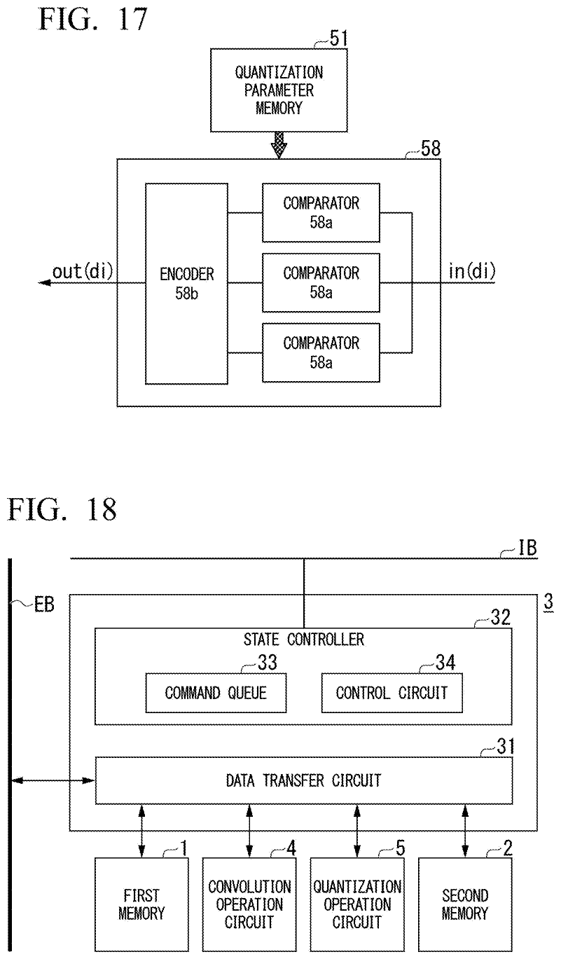

FIG. 17 is an internal block diagram of a quantization unit 58.

The quantization unit 58 performs quantization of an element in(di) of the output data front the vector operation circuit 52. The quantization unit 58 has a comparator 58a and an encoder 58b. The quantization unit 58 performs, on output data (16 bits/element) from the vector operation circuit 52, an operation (Equation 6) of the quantization layer 224 in the quantization operation layer 220. The quantization unit 58 reads the necessary quantization parameter q(th0, th1, th2) from the quantization parameter memory 51 and uses the comparator 58a to compare the input in(di) with the quantization parameter q. The quantization unit 58 uses the encoder 58b to quantize the comparison results from the comparator 58a to 2 bits/element. In Equation 4, a(c) and #(c) are parameters that are different for each variable c. Thus, the quantization parameter q(th0, th1, th2), which reflects α(c) and β(c), is a parameter that is different for each value of in(di).

The quantization unit 58 classifies the input in(di) into one of four regions (for example, in≤th0, th0<in≤th1, th1<in≤th2, th2<in) by comparing the input in(di) with the three threshold values th0, th1 and th2. The classification result is encoded in 2 bits and output. The quantization unit 58 can also perform batch normalization and activation function operations in addition to quantization in accordance with the setting of the quantization parameter q(th0, th1, th2).

The quantization unit 58 can implement the batch normalization operation indicated in Equation 4 in addition to quantization by performing quantization with the threshold value th0 set to β(c) in Equation 4 and with the differences (th1−th0) and (th2−th1) between the threshold values set to α(c) in Equation 4. The value of α(c) can be made smaller by making (th1−th0) and (th2−th1) larger. The value of α(c) can be made larger by making (th1−th0) and (th2−th1) smaller.

The quantization unit 58 can implement the ReLU operation in the activation function in addition to quantization of the input in(d. For example, the output value of the quantization unit 58 is saturated in the regions where in(di)≤th0 and th2<in(di). The quantization unit 58 can implement the activation function operation in addition to quantization by setting the quantization parameter q so that the output becomes nonlinear.

The state controller 54 controls the states of the vector operation circuit 52 and the quantization circuit 53. Additionally, the state controller 54 is connected to the controller 6 by the internal bus IB. The state controller 54 has a command queue 55 and a control circuit 56.

The command queue 55 is a queue in which commands C5 for the quantization operation circuit 5 are stored, and is constituted, for example, by an FIFO memory. Commands C5 are written into the command queue 55 via the internal bus IB.

The control circuit 56 is a state machine that decodes commands C5 and that controls the vector operation circuit 52 and the quantization circuit 53 based on the commands C5. The control circuit 56 is configured similarly to the control circuit 46 of the state controller 44 in the convolution operation circuit 4.

The quantization operation circuit 5 writes quantization operation output data having Rd elements into the first memory 1. The preferable relationship between Bd and Bc is indicated by Equation 7. In Equation 7, n is an integer.

Bd=2ⁿ·Bc [Equation 7]

The execution model generation unit 321 determines, from the quantization information input as network information NW, whether or not there are pooling operations and the types thereof (average pooling, max pooling, etc.), whether or not there are batch normalization operations and the schemes thereof, whether or not there are activation function operations and the schemes thereof (ReLU operations, etc.), the quantization schemes (number of bits, etc.), and whether or not there are other operations. In the case in which the hardware scale of the NN execution model 100 (neural network hardware model 400, neural network hardware 600) to be generated is included in the hardware information HW, the execution model generation unit 321 adjusts the configurations of the operation devices in the quantization operation circuit 5 in accordance with the designated scale.

### <DMAC Generation Step (S13-3)>

The execution model generation unit 321 generates the DMAC 3 of the NN execution model 100 based on the hardware information HW and the network information NW (DMAC generation step). The execution model generation unit 321 generates a hardware model of the DMAC 3 from information input as network information NW. The hardware model may be at the behavior level or may be at the RTL (Register Transfer Level), may be a net list indicating connections between gates and circuit modules, or may be a combination thereof. Hereinafter, an example of a hardware model of the DMAC 3 that is generated will be explained.

FIG. 18 is an internal block diagram of a generated DMAC 3.

The DMAC 3 has a data transfer circuit 31 and a state controller 32. The DMAC 3 has a state controller 32 that is dedicated to the data transfer circuit 31 so that, when a command is input, DMA data transfer can be implemented without requiring an external controller.

The data transfer circuit 31 is connected to the external bus EB and performs DMA data transfer between the first memory 1 and an external memory such as a DRAM. Additionally, the data transfer circuit 31 performs DMA data transfer between the second memory 2 and an external memory such as a DRAM. Additionally, the data transfer circuit 31 performs data transfer between the convolution operation circuit 4 and an external memory such as a DRAM. Additionally, the data transfer circuit 31 performs data transfer between the quantization operation circuit 5 and an external memory such as a DRAM. The number of DMA channels in the data transfer circuit 31 is not limited. For example, the data transfer circuit 31 may have a DMA channel dedicated to each of the first memory 1 and the second memory 2.

The state controller 32 controls the state of the data transfer circuit 31. Additionally, the state controller 32 is connected to the controller 6 via the internal bus 18. The state controller 32 has a command queue 33 and a control circuit 34.

The command queue 33 is a queue in which commands C3 for the DMAC 3 are stored, and is constituted, for example, by an FIFO memory. One or more commands C3 are written into the command queue 33 via the internal bus 115.

The control circuit 34 is a state machine that decodes the commands C3 and that sequentially controls the data transfer circuit 31 based on the commands C3. The control circuit 34 is configured similarly to the control circuit 46 of the state controller 44 in the convolution operation circuit 4.

The execution model generation unit 321 determines the number of DMA channels, the data bus width, and the like in the DMAC 3 from information input as network information NW.

For example, the execution model generation unit 321 generates a DMAC 3 with specifications (data bus width, etc.) matching the specifications of a host-side external bus EB. By increasing the data bus width and the number of DMA channels, the data transfer rate between the external memory and the first memory 1 and second memory 2 can be increased.

### <Learning Step (S4)>

In step S14, the learning unit 322 and the inference unit 323 of the neural network generation device 300 use the training data set DS to learn the parameters to be learned in the generated NN execution model 100 (learning step). The learning step (S14) has, for example, a teamed parameter generation step (S14-1) and an inference testing step (S14-2).

### <Learning Step: Learned Parameter Generation Step (S14-1)>

The learning unit 322 uses the NN execution model 100 and training data D1 to generate learned parameters PM. The learned parameters PM are learned weight w, quantization parameters q, and the like.

For example, in the case in which the NN execution model 100 is an execution model for a CNN 200 for implementing image recognition, the training data D1 is a combination of an input image and teacher data T. The input image is input data a input to the CNN 200. The teacher data T is the type of an object captured in an image, the presence or absence of a detection target in the image, coordinate values of a detection target in the image, or the like.

The learning unit 322 generates the learned parameters PM by means of teacher-based learning using error backpropagation, which is a known technique, or the like. The learning unit 322 determines a difference E between the output front the NN execution model 100 for an input image and teacher data T corresponding to the input image by means of a loss function (error function), and updates the weight w and the quantization parameter q so as to make the difference E smaller.

For example, when updating the weight w, the gradient of a loss function relating to the weight w is used. The gradient is computed, for example, by taking the derivative of the loss function. In the case in which the error backpropagation method is used, the gradient is computed by backward propagation.

When computing the gradient and updating the weight w, the learning unit 322 increases the precision of operations associated with convolution operations. Specifically, a 32-hit floating-point weight w, which is more precise than the low-bit weight w (e.g., 1 bit) used by the NN execution model 100, is used for training. Additionally, the precision of convolution operations implemented by the convolution operation circuit 4 in the NN execution model 100 is increased.

When computing the gradient and updating the weight w, the learning unit 322 increases the precision of operations associated with the activation function. Specifically, a sigmoid function, which is more precise than an activation function such as the ReLU function implemented by the convolution operation circuit 5 in the NN execution model 100, is used tor training.

Meanwhile, when the learning unit 322 computes output data with respect to an input image by means of forward propagation, operations based on the NN execution model 100 are implemented without increasing the precision of convolution operations and operations associated with the activation function. The highly precise weights w used when updating the weights w are converted to fewer bits by means of a lookup table or the like.

When computing the gradients and updating the weights w, the earning unit 322 can prevent decreases in the precision of intermediate data in operations by increasing the precision of convolution operations and operations associated with the activation function, thereby generating learned parameters PM by which high inference precision can be realized.

Meanwhile, when computing output data with respect to an input image, the learning unit 322 implements operations based on the NN execution model 100 without increasing the precision of forward propagation operations. For this reason, the output data computed by the learning unit 322 matches the output data front the NN execution model 100 using a learned parameter PM that has been generated.

### <Learning Step: Inference Testing Step (S14-2)>

The inference unit 323 uses the learned parameters PM generated by the teaming unit 322, the NN execution model 100 and the test data D2 to implement an inference test. For example, in the case in which the NN execution model 100 is an execution model of a CNN 200 for implementing image recognition, the test data D2, like the training data D1, is a combination of an input image and teacher data T.

The inference unit 323 displays the progress and results of the inference test on the display unit 350. The results of the inference test are, for example, the correct answer rate with respect to the test data D2.

### <Confirmation Step (S15)>

In step S15, the inference unit 323 in the neural network generation device 300 displays, on the display unit 350, a message prompting the user to input confirmation of the results by using the manual operation input unit 360 and a GUI image necessary for inputting information. The user inputs, from the manual operation input unit 360, whether or not the results of the inference test are acceptable. If an input indicating acceptability of the inference test results has been input by the user from the manual operation input unit 360, then the neural network generation device 300 next implements step S16. If an input indicating that the results of the inference test are unacceptable to the user is input from the manual operation input unit 360, then the neural network generation device 300 implements step S12 again. The neural network generation device 300 may return to step S11 and have the user input the hardware information HW again.

### <Output Step (S16)>

In step S16, the hardware generation unit 324 in the neural network generation device 300 generates a neural network hardware model 400 based on the hardware information HW and the NN execution model 100.

### <Software Generation Step (S17)>

In step S17, the software generation unit 325 in the neural network generation device 300 generates software 500 for operating neural network hardware 600 (the neural network hardware model 400 installed in the operated hardware) based on the network information NW, the NN execution model 100, and the like. The software 500 includes software for transferring learned parameters PM to the neural network hardware 600 as needed.

The software generation step (S17) includes, for example, an input data partitioning step (S17-1), a network partitioning step (S17-2, and an allocation step (917-3).

### <Input Data Partitioning Step (S17-1): Data Partitioning>

The software generation unit 325 partitions input data a for convolution operations in the convolution layers 210 based on the memory capacities of memory to be allocated as the first memory 1 and the second memory 2, the specifications and the sizes (Bc and Bd) of the operation devices, or the like. The method for partitioning into the partial tensor, and the number if partitions are not particularly limited. The partial tensors are formed, for example, by partitioning the input data a(x+i, y+j, c) into a(x+i, y+j, co).

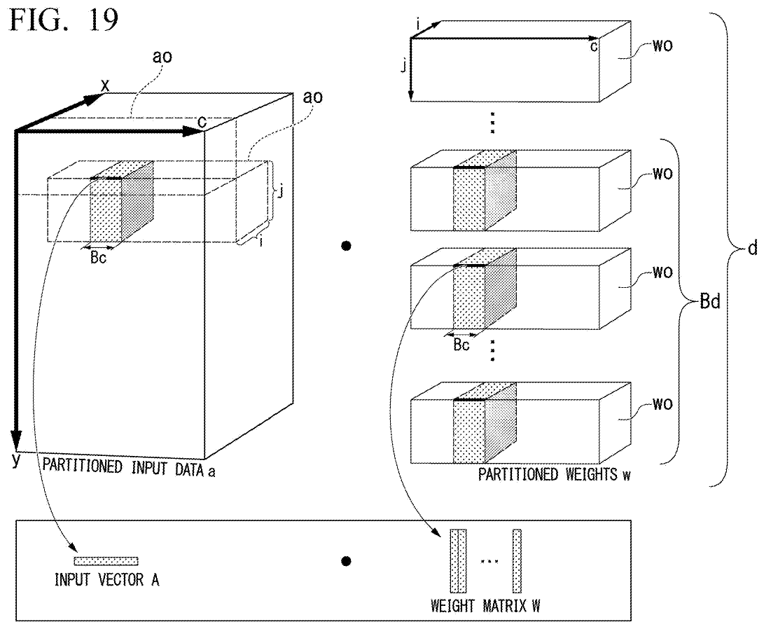

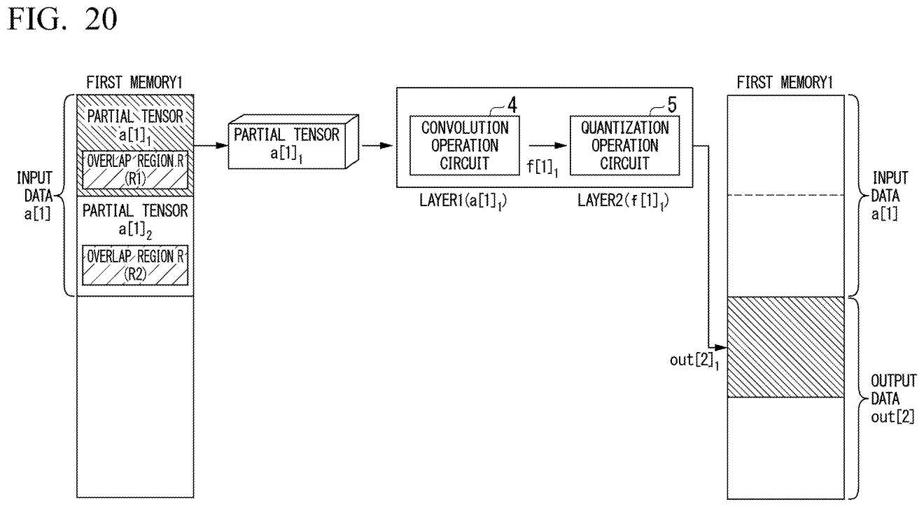

FIG. 19 is a diagram for explaining data partitioning and data expansion in a convolution operation.

In data partitioning in a convolution operation, the variable c in Equation 1 is partitioned into blocks of size fc, as indicated by Equation 8. Additionally, the variable d in Equation 1 is partitioned into blocks of size Bd, as indicated by Equation 9. In Equation 8, co is an offset, and ci is an index from 0 to (Bc−1). In Equation 9, do is an offset, and di is an index front 0 to (Bd−1). The size Bc and the size Bd may be the same.

c=co·Bc+ci [Equation 8]

d=do−Bd+di [Equation 9]

The input data a(x+i, y+j, c) in Equation 1 is partitioned into the size Bc in the c-axis direction and is expressed as the partitioned input data a(x+i, y+j, co). In the explanation below, input data a that has been partitioned is also referred to as “partitioned input data a”.

The weight w(i, j, c, d) in Equation 1 is partitioned into the size Bc in the c-axis direction and into the size Bd in the d-axis direction, and is expressed as the partitioned weight w (i, j, co, do). In the explanation below, a weight w that has been partitioned will also referred to as a “partitioned weight w”.

The output data f(x, y, do) partitioned into the size Bd is determined by Equation 10. The final output data j(x, y, d can be computed by combining the partitioned output data f(x, y, do).

f(x,y,do)=Σᵢ^{K}Σⱼ^{K}Σ_{co}^{C/Bc}a(s·x+i,s·y+j,co)·w(i,j,co,do) [Equation 10]

### <Input Data Partitioning Step (S17-1): Data Expansion>

The software generation unit 325 expands the input data a and the weights w that have been partitioned in a convolution operation circuit 4 in the NN execution model 100.

The partitioned input data a(x+i, y+j, co) is expanded into vector data having Bc elements. The elements in the partitioned input data a are indexed by ci (where 0≤ci<Bc). In the explanation below, partitioned input data a expanded into vector data for each of i and j will also be referred to as “input vector A”, An input vector A has elements from partitioned input data a(x+i, y+j, co×Bc) to partitioned input data a(x+i, y+j. co×Bc+(Bc−1)).

The partitioned weights w(i, j, co, do) are expanded into matrix data having Bc×Bd elements. The elements of the partitioned weights w expanded into matrix data are indexed by ci and di (where 0≤di<Bd). In the explanation below, a partitioned weight w expanded into matrix data for each of i and j will also be referred to as a “weight matrix W”. A weight matrix W has elements from a partitioned weight w(i, j, co×Bc, do×Bd) to a partitioned weight w(i, j, co×Bc+(Bc−1), do×Bd+(Bd−1)).

Vector data is computed by multiplying an input vector A with a weight matrix W. Output data f(x, y, do) can be obtained by formatting vector data computed for each of i, j, and to as a three-dimensional tensor. By expanding data in this manner, the convolution operations in the convolution layers 210 can be implemented by multiplying vector data with matrix data.

For example, suppose that the size of the input data a is X×Y×C, the size of the weights w is K×K×C×D. and the size of the output data f is X×Y×D. The output data f(x, p, do) partitioned into the size Bd in the d-axis direction can be computed by performing convolution operations, for each value of i, j, and co, on the input data a(x+i, y+j, co) partitioned into the size Bc in the c-axis direction and the weights w(i, j, co, do) partitioned into the sizes Bc and Bd, and summing the results thereof.

If the elements of the output data f are 16 bits long, then the size of the output data f(x, y, do) partitioned into the size Bd in the d-axis direction is 16·X·Y·Bd hits. Meanwhile, if the elements of the input data a are 2 bits long, then the size of the input data a necessary for computing the output data f partitioned into the size 8d is 2·X·Y·Bc bits. Additionally, if the elements of the weights w are 1 bit long, then the size of the weights w necessary for computing the output data f partitioned into the size Bd is 1·K·K·Be·Bd bits.

The software generation unit 325 partitions the input data a into units (partial tensors) that are easy to process with the neural network hardware 600 based on the memory capacities of memory to be allocated as the first memory 1 and the second memory 2, the specifications and the sizes (Be and Bd) of the operation devices, and the like. For example, the software generation unit 325 partitions the input data a into partial tensors so that multiple units of the partitioned input data a (2·X·Y·Bc bits) are stored in the first memory 1. The software generation unit 325 partitions the input data a in each layer. The units that are easy to process with the neural network hardware 690 are determined based on the number of operation devices that can perform operations in parallel in the neural network hardware 600, the capacity and bandwidth of the first memory 1 or the second memory 2, the amount of power consumed, the operating frequency, or the like. For example, if the number of operation devices that can perform operations in parallel is large, then the number of partitions of the input data a is preferably small.

### <Network Partitioning Step (S17-2)>

The software generation unit 325 partitions the networks (layers) in the CNN 200, and maps them to the convolution operation circuit 4 and the quantization operation circuit 5, which are formed into a loop (network partitioning step).

FIG. 20 to FIG. 23 are diagrams for explaining the network partitioning step. In the present embodiment, an example in which three operations constituted by convolution operations and quantization operations are performed (layer 1 to layer 6 are implemented) will be explained. In the explanation hereinafter, the input data a for the layer n input to the convolution operation circuit 4 is referred to as “a[n)”. Additionally, the output data f from the layer n, which is output from the convolution operation circuit 4, is referred to as “fin]”. The output data from the quantization operation (quantization operation output data), which is output from the quantization operation circuit 5, is referred to as “out[n]”.

The software generation unit 325, in the input data partitioning step (S17-1), partitions the layer-1 input data a[1], which is input to the convolution operation circuit 4, for example, into a “first partial tensor at[1]₁” and a “second partial tensor a[1]₂”.

The software generation unit 325 selects, among the partitioned input data a[1], data that the DMAC 3 is to transfer to the first memory 1. The software generation unit 325 selects data that can be transferred to unused areas of the first, memory 1 in accordance with the order of convolution operations,

Due to the nature of convolution operations, the convolution operation on the first partial tensor a[1]₁ requires a partial area (hereinafter also referred to as the “overlap region R (R1)”) of the second partial tensor a[1]₂ the partial area being adjacent to the first partial tensor a[1]₁. For this reason, when implementing a convolution operation on the first partial tensor a[1]₁, the data in the overlap region R (R1) is also read into and stored in the first memory 1 together with the fir-t partial tensor a[1]₁. The software generation unit 325, for example, includes the overlap region R (R1) in the first partial tensor a[1]₁ in a form that is easy to address in memory.

Similarly, the convolution operation on the second partial tensor a[1]₂ requires a partial area (hereinafter also referred to as the “overlap region R (R2)”) of the first partial tensor a[1]₁, the partial area being adjacent to the second partial tensor a[1]₂. For this reason, when implementing a convolution operation on the second partial tensor a[1]₂, the data in the overlap region R (R2) is also read into the first memory 1 together with the second partial tensor a[1]₂. The software generation unit 325, for example, includes the overlap region R (R2) in the second partial tensor a[1]₂ in a form that is easy to address in memory.

Convolution operations have the property wherein the data size becomes smaller each time an operation is performed. For this reason, as the consecutive number of convolution operations increases, the overlap region R read together with the partial tensor first stored in the first memory 1 becomes larger. As the consecutive number of convolution operations increases, the operation efficiency becomes higher. Meanwhile, the data size of the overlap region R that is read in association with each partial tensor increases as the overlap region R becomes larger, and the number of memory transfers of overlapping data increases.

The software generation unit 325 determines the consecutive number of convolution operations by considering the data amount of the adjacent region R that can be transferred to the unused area of the first memory 1. In the present embodiment, the software generation unit 325 selects to consecutively implement, twice, operations constituted by a convolution operation and a quantization operation (to implement layer 1 to layer 4).

As illustrated in FIG. 20, the convolution operation circuit 4, to which the first partial tensor a[1]₁ has been input, outputs output data f[1]₁ from a layer-1 convolution operation to the quantization operation circuit 5 via the second memory 2. The quantization operation circuit 5, to which f[1]₁ has been input, inputs the output out[2]₁ of a layer-2 quantization operation to the first memory 1.

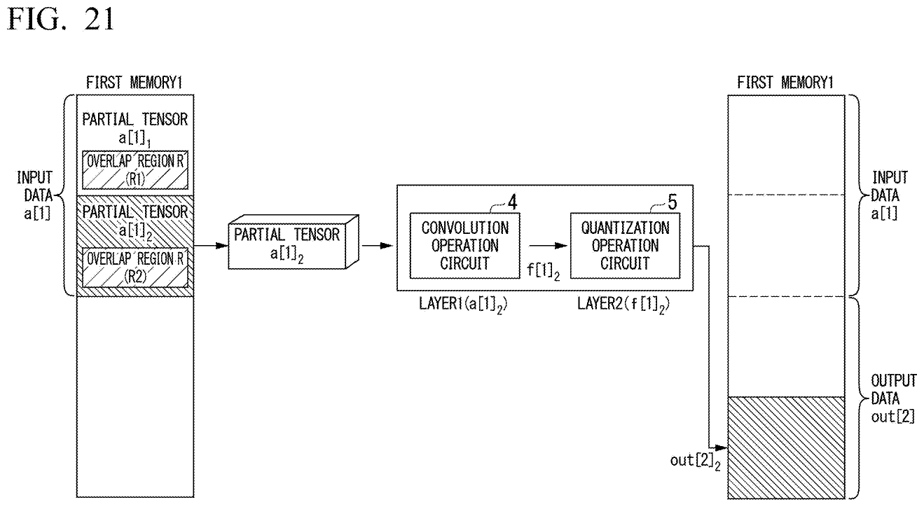

As illustrated in FIG. 21, the convolution operation circuit 4, to which the second partial tensor a[1]₂ has been input, outputs output data f[1]₂, from a layer-1 convolution operation to the quantization operation circuit 5 via the second memory 2. The quantization operation circuit 5, to which f[1]₂ has been input, inputs the output out[2]₂ of a layer-2 quantization operation to the first memory 1.

The output out[2]₁ from the layer-2 quantization operation and the output out[2]₂ from the layer-2 quantization operation are combined to yield the output out[2] of the layer-2 quantization operation.

The output out[2] from the layer-2 quantization operation includes all of the input data a[3] for a layer-3 convolution operation. This is because the overlap regions R (R1, R2) associated with the first partial tensor a[1]₁ and the second partial tensor a[1]₂ stored in the first memory 1 are selected so as to be able to implement layer 1 to layer 4.

The software generation unit 325 partitions the output out[2] from the layer-2 quantization operation, which is the input data a[3] that is the layer-3 input data a input to the convolution operation circuit 4, for example, into the “first partial tensor a[3]₁” and the “second partial tensor a[3]₂.”, based on partitioning units determined in the input data partitioning step (S17-1).

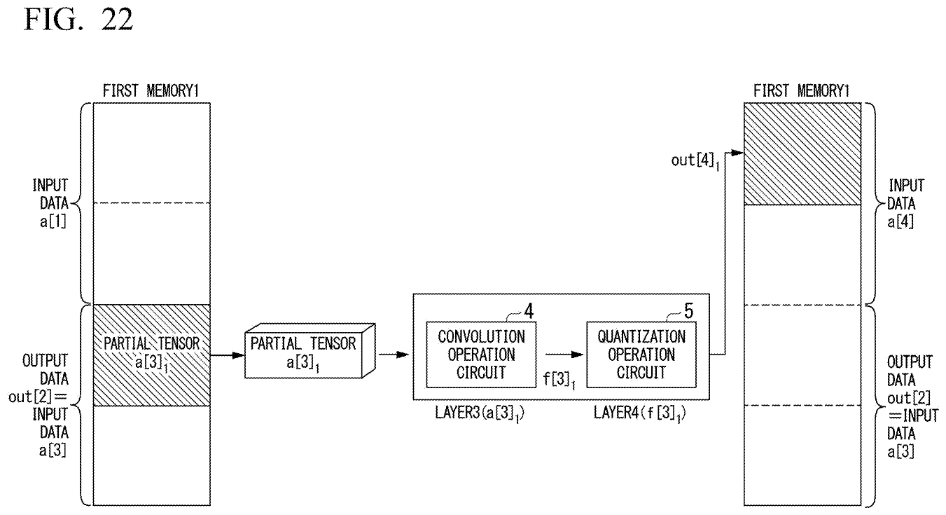

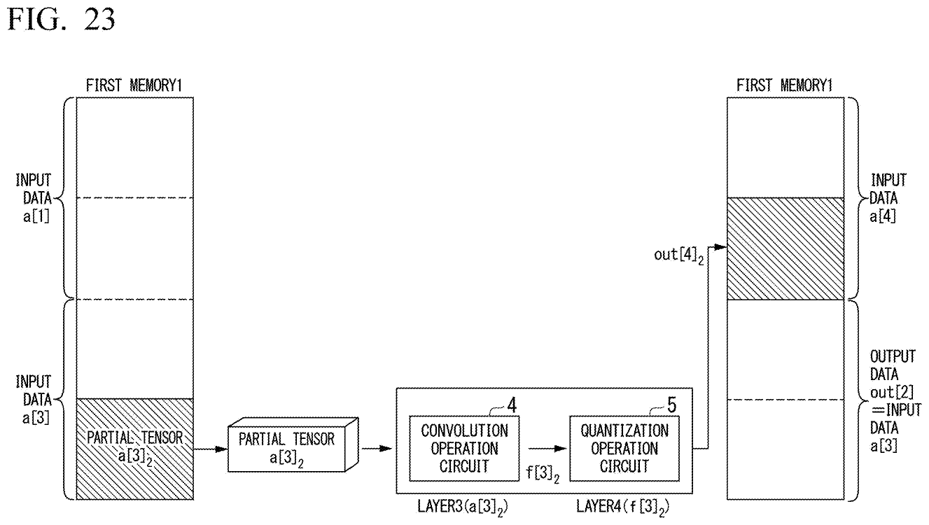

As illustrated in FIG. 22, the convolution operation circuit 4, to which the first partial tensor a[3]₁ has been input, outputs the output data f[3]₁ from the layer-3 convolution operation to the quantization operation circuit 5 via the second memory 2. The quantization operation circuit 5, to which f[3]₁ has been input, inputs the output out[4]₁ from the layer-4 quantization operation to the first memory 1.

In this case, the input data a[1]₁ is already present in the memory area of the first memory 1 for storing the output out[4]₁. A memory area for holding the output data f is secured by freeing the memory area that has not been referenced for the longest time among the memory areas that are already used in the first memory 1. In the present embodiment, the input data a[1]₁ has not been referenced for the longest time. Therefore, said memory area is freed. Additionally, if there is a need for separately saving the data that was held in the freed memory area then said data is saved to the external memory before the memory area is freed.

As illustrated in FIG. 23, the convolution operation circuit 4, to which the second partial tensor a[3]₂ has been input, outputs the output data f[3]₂ from the layer-3 convolution operation to the quantization operation circuit 5 via the second memory 2. The quantization operation circuit 5, to which f[3]₂ has been input, inputs the output out[4]₂ from the layer-4 quantization operation to the first memory 1.

The output out[4] from the layer-4 quantization operation does not include all of the input data a[5] for a layer-5 convolution operation. This is because the overlap regions R (R1, R2) associated with the first partial tensor a[1]₁ and the second partial tensor a[1]₂ stored in the first memory 1 are selected so as to be able to implement layer 1 to layer 4.

Therefore, the output out[4] from the layer-4 quantization operation is saved to the external memory by using the DMAC 3. The networks (layers) in the CNN 200 are partitioned into layer 4 and layer 5.

The software generation unit 325 adds code for generating the layer-5 input data a[5] to the software 500. The code makes the external host CPU or the like to implement data shaping or the like on the output out[4], saved to the external memory as needed.

The software generation unit 325 partitions the layer-5 input data a[5] input to the convolution operation circuit 4, for example, into the “first partial tensor a[5]₁” and the “second partial tensor a[5]₂”. In this case, the first partial tensor a[5]₁ and the second partial tensor a[5]₂ are contained in an overlap region R taking into consideration the consecutive number of convolution operations to be implemented thereafter.

The software generation unit 325 implements network (layer) partitioning of the CNN 200, as mentioned above, on the entire CNN 200. The software generation unit 325 implements network (layer) partitioning of the CNN 200 so as to minimize the memory transfer between the first memory 1 and the external memory by the DMAC 3 as much as possible.

Even in the case in which an operation for modifying the tensor shape of the input data a is included in the CNN 200, the networks (layers) are partitioned before said operation. The operation for modifying the tensor shape of the input data a is, for example, an operation for reducing the input data a in the depth direction (c-axis direction) and extending the input data a in the planar direction (xy-axis directions), an operation for combining the tensors (data), or the like.

Additionally, even if the CNN 200 includes convolution operations with a stride greater than 1, the networks (layers) are partitioned after the convolution operation. This is because the data partitioning size changes before and after convolution operations with a stride greater than 1. If the size of the output data f of a convolution operation in the x-axis direction or the y-axis direction changes by a certain amount or greater (for example, by at least two times or by at most 0.5 times) in comparison with the input data a for the convolution operation, then the networks (layers) are preferably partitioned after the convolution operation.

In the examples described above, the networks (layers) in the CNN 200 are partitioned based on the capacity of the first memory 1, and explanations of partitioning based on the capacity of the second memory 2 are omitted. The software generation unit 325 partitions the networks (layers) of the CNN 200 based on the capacities of the first memory 1 and the second memory 2.

In the network partitioning step (S17-2) in the present embodiment, the software generation unit 325 may, for example, roughly partition the networks (layers) in the CNN 200 by assuming that the first memory 1 and the second memory 2 have sufficiently large capacities for the input data a or the like. The rough partitioning is implemented, for example, before and after the above-mentioned operations requiring network (layer) partitioning. The network partitioning step (S17-2) can be kept from becoming complicated by performing network ‘(layer) partitioning based on the capacities of the first memory 1 and the second memory 2, as mentioned above, after the rough partitioning (multi-stage network partitioning).

### <Allocation Step (S17-3)>

The software generation unit 325 generates software 500 for allocating the partitioned operations to the neural network hardware 600 for implementation (allocation step). The generated software 500 includes commands C3, commands C4, and commands C5.

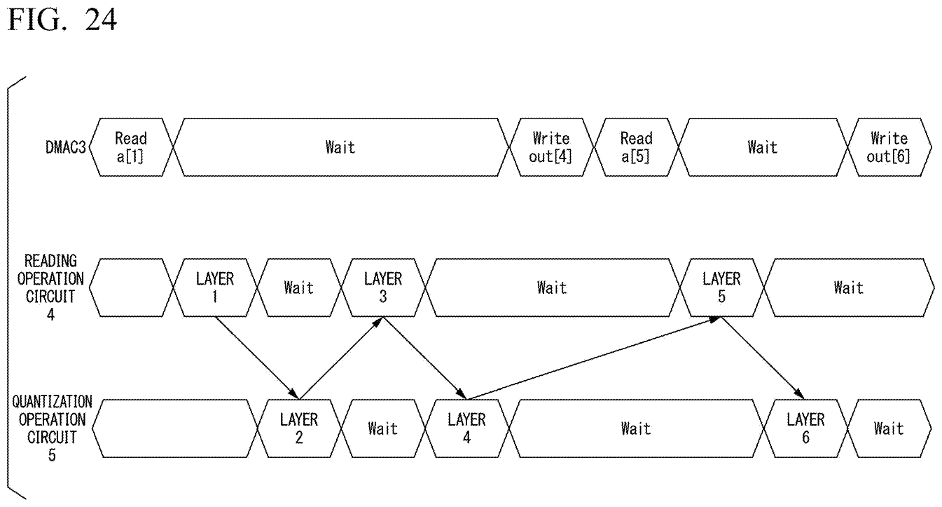

FIG. 24 is a diagram illustrating a timing chart for neural network hardware 600 to which partitioned operations have been allocated. The software generation unit 325 basically allocates the partitioned operations to neural network hardware 600 in network (layer) order.

In the example illustrated in FIG. 24, a command C3 is generated for the DMAC 3 to transfer the input data a[1] from the external memory to the first memory 1. Next, a command C4 for the convolution operation circuit 4 to implement a convolution operation on the first partial tensor a[1]₁ and a command C5 for the quantization operation circuit 5 to implement a quantization operation on the output f[1]₁ are generated (operations illustrated in FIG. 20). Next, a command C4 for the convolution operation circuit 4 to implement a convolution operation on the first partial tensor a[1]₂ and a command C5 for the quantization operation circuit 5 to implement a quantization operation on the output f[1]₂ are generated (operations indicated in FIG. 21).

Next, a command C4 and a command C5 are similarly generated tor performing operations on the output out[2] from the layer-2 quantization operation, which is also the layer-3 input data a[3] input to the convolution operation circuit 4 (operations indicated in FIG. 22 and FIG. 23).

Next, a command C3 for the DMAC 3 to transfer the output out[4] from the first memory 1 to an external memory is generated. Furthermore, a command C3 for the DMAC 3 to transfer the input data a[5] from the external memory to the first memory 1 is generated.

Next, a command C4 and a command C5 for performing operations on the input data a[5] are similarly generated.

The commands C3, the commands C4, and the commands C5 include commands for controlling semaphores S.

The software generation unit 325 implements network (layer) partitioning of the CNN 200 so as to minimize memory transfer between the first memory 1 and the external memory by the DMAC 3 as much as possible. Therefore, the time spent by the convolution operation circuit 4 and the quantization operation circuit 5 in wailing for memory transfer by the DMAC 3 is shortened, thereby increasing the operating efficiency of the neural network hardware 600.

In the NN execution model 100, since the circuits are formed in a loop, the software 500 includes a program for appropriately updating, as needed, the parameters in the convolution operation circuit 4 and the quantization operation circuit 5, which change in each layer.

The software generation unit 325 realizes the respective operations of the partitioned networks (layers) by combining multiple commands C3, C4, and C5 in accordance with the neural network hardware 600. For example, a convolution operation in which the size of the weights w is 3×3 is realized by combining nine convolution operations in which the size of the weights w is 1×1 in accordance with the neural network hardware 600. Additionally, multiple partitioned operations obtained by network partitioning can be realized with a single command. For example, the operations of the convolution operation circuit 4 and the quantization operation circuit 5 can be controlled by commands obtained by combining the commands C3 and C4. In this case, the combined commands are executed by being recoded as operations of the convolution operation circuit 4 and the convolution operation circuit 5 in the neural network hardware 600.

In the case in which the operations in the CNN 200 include operations that cannot be performed by the neural network hardware 600, code is added to the software 500 for having an external operation device perform the operations that cannot be performed by the neural network hardware 60. The software 500 transfers intermediate data to an external operation device such as an external host CPU, and makes the external operation device perform the operations. The software 500 inputs the operation results from the external operation device to the first memory 1 and the second memory 2, and makes the neural network hardware 600 resume operations on the operation results from the external operation device.

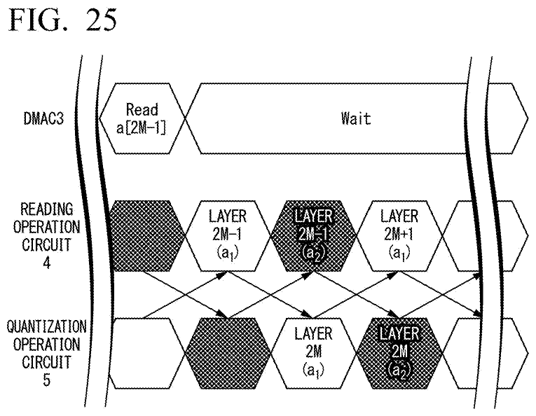

FIG. 25 is a timing chart indicating another example of allocation to neural network hardware 600.

The convolution operations and the quantization operations corresponding to the first partial tensor a₁ can be implemented independent of the convolution operations and the quantization operations corresponding to the second partial tensor a₂, as illustrated in FIG. 25. Therefore, the software generation unit 325 may allocate the partitioned operations to the neural network hardware 600 with the order of some of the network (layers) switched.

The convolution operation circuit 4 performs a layer-(2M−1) convolution operation corresponding to the first partial tensor a₁ (in FIG. 25, the operation indicated by “Layer 2M−1 (a₁)”. Thereafter, the convolution operation circuit 4 performs a layer-(2M−1) convolution operation corresponding to the second partial tensor 62 (in FIG. 25, the operation indicated by “Layer 2M−1 (a₂)”). Additionally, the quantization operation circuit 5 performs a layer-2M quantization operation corresponding to the first partial tensor a, (in FIG. 25, the operation indicated by “Layer 2M (a₁)”). Thu's, the NN execution model 100 can implement the layer-(2M−1) convolution operation corresponding to the second partial tensor a₂ and the layer-2M quantization operation corresponding to the first partial tensor a₁ in parallel.

Next, the convolution operation circuit 4 performs a layer-(2M+1) convolution operation corresponding to the first partial tensor at (in FIG. 25, the operation indicated by “Layer 2M+1 (at)”). Additionally, the quantization operation circuit 5 performs a layer-2M quantization operation corresponding to the second partial tensor a, (in FIG. 25, the operation indicated by “Layer 2M (a₂)”). Thus, the NN execution model 100 can implement the layer-(2M+1) convolution operation corresponding to the first partial tensor at and the layer-2M quantization operation corresponding to the second partial tensor a₂ in parallel.

By partitioning the input data a into partial tensors, the neural network hardware 600 can make the convolution operation circuit 4 and the quantization operation circuit 5 operate in parallel. As a result thereof, die time during which the convolution operation circuit 4 and the quantization operation circuit 5 are standing by can be reduced, thereby increasing the operation processing efficiency of the neural network hardware 600. Although the number of partitions to partial tensors in the operating example indicated in FIG. 25 was two, the neural network hardware 600 can similarly make the convolution operation circuit 4 and the quantization operation circuit 5 operate in parallel even in cases in which the number of partitions is greater than two.

As the method for performing operations on the partial tensors, an example in which operations were performed on the partial tensors in the same layer by the convolution operation circuit 4 or the quantization operation circuit 5, then operations were performed on the partial tensors in the next layer (method 1) has been described. For example, as indicated in FIG. 25, the convolution operation circuit 4 performs layer-(2M−1) convolution operations corresponding to the first partial tensor a, and the second partial tensor a₂ (in FIG. 25, the operations indicated as layer 2M−1 (a₁) and layer 2M−1 (a₂)), then performs layer-(2M+1) convolution operations corresponding to the first partial tensor a t and the second partial tensor a (in FIG. 25, the operations indicated as layer 2M+1) and layer 2M+1 (a₂)).

However, the method for performing operations on the partial tensors is not limited to the above. The method for performing operations on the partial tensors may be a method of performing operations on the partial tensors for some of the multiple layers, then performing operations on the remaining partial tensors (method 2). For example, the convolution operation circuit 4 may perform layer-(2M−1) convolution operations corresponding to the first partial tensor a₁ and layer-(2M+1) convolution operations corresponding to the first partial tensor a₁, then perform layer-(2M−1) convolution operations corresponding to the second partial tensor a₂ and layer-(2M+1) convolution operations corresponding to the second partial tensor a₂.

Additionally, the method for performing operations on the partial tensors may be a method for performing operations on the partial tensors by combining method 1 and method 2. However, in the case in which method 2 is used, the operations must be implemented in accordance with the dependence of the partial tensors on the order of the operations.

The possibility of implementing operations for the partial tensors in parallel, as mentioned above, may be determined based on unused areas of the first memory 1 and the second memory 2 rather than the dependence of the partial tensors on the order of the operations. In the case in which there are no unused areas necessary for parallel operations in the first memory 1 and the second memory 2, control is implemented for performing some of the operations among the parallel operations in a time-divided manner instead of being performed in parallel.

For example, in the case in which convolution operations are to be implemented by changing the weights w on the same input data a, the convolution operations can be efficiently performed by using the same input data a consecutively. For this reason, the software generation unit 325 switches the order of partitioned operations so that operations using the same data stored in the first memory 1 and the second memory 2 are performed consecutively as much as possible.

As explained above, with the neural network generation device 300 and the neural network control method according to the present embodiment, it is possible to generate and control a neural network that is embeddable in an embedded device such as an IoT device, and that can be made to operate with high performance. According to the software generation program of the present embodiment, the neural network generation device 300 can generate software 500 for operating the neural network generation device 300 with high efficiency and at high speed.

While a first embodiment of the present invention has been described in detail with reference to the drawings above, the specific structure is not limited to this embodiment, and design changes or the like within a range not departing from the spirit of the present invention are also included. Additionally, the structural elements indicated in the embodiments and the modified examples described above may be combined as appropriate.

### Modified Example 1

In the above embodiment, the first memory 1 and the second memory 2 were separate memories. However, the first memory 1 and the second memory 2 are not limited to such an embodiment. The first memory 1 and the second memory 2 may, for example, be a first memory area and a second memory area in the same memory.

### Modified Example 2

For example, the data input to the NN execution model 100 or the neural network hardware 600 described in the above embodiment need not be limited to a single form, and may be composed of still images, moving images, audio, text, numerical values, and combinations thereof. The data input to the NN execution model 100 or the neural network hardware 600 is not limited to being measurement results from a physical amount measuring device such as an optical sensor, a thermometer, a Global Positioning System (GPS) measuring device, an angular velocity measuring device, a wind speed meter, or the like that may be installed in an edge device in which the neural network hardware model 600 is provided. The data may be combined with different information such as base station information received from a peripheral device by cable or wireless communication, information from vehicles, ships or the like, weather information, peripheral information such as information relating to traffic conditions, financial information, personal information, or the like.

### Modified Example 3

While the edge device in which the neural network hardware 600 is provided is contemplated as being a communication device such as a mobile phone or the like driven by a battery or the like, a smart device such as a personal computer, a digital camera, a game device, or a mobile device in a robot product or the like, the edge device is not limited thereto. Effects not obtained by other prior examples can be obtained by utilization in products for which there is a demand for long-term driving or for reducing product heat generation, or for restricting the peak electric power that can be supplied by Power on Ethernet (PoE) or the like. For example, by applying the invention to an on-board camera mounted on a vehicle, a ship, or the like, or to a security camera or the like provided in a public facility or on a road, not only can long-term image capture be realized, but also, the invention can contribute to weight reduction and higher durability. Additionally, similar effects can be achieved by applying the invention to a display device such as a television or a monitor, to a medical device such as a medical camera or a surgical robot, to a work robot used at a manufacturing site or at a construction site, or the like.

A program for an embodiment described above may be recorded on a computer-readable recording medium, and the program recorded on this recording medium may be rad into a computer system and executed to realize the embodiment. The “computer system” mentioned here includes an OS and hardware such as peripheral devices. Additionally, the “computer-readable recording medium” refers to a portable medium such as a flexible disk, a magneto-optic disk, a ROM, or a CD-ROM, or to a storage medium such as a hard disk internal to the computer system. Furthermore, the “computer-readable recording medium” may include media that dynamically hold the program for a brief period of time, including communication lines in the case in which the program is transmitted via a network such as the internet and communication lines such as telephone lines, and media that hold the program for a certain period of time, such as transitory memory inside the computer system functioning as a server or a client in such cases. Additionally, the above-mentioned program may be for realizing just some of the aforementioned functions, and furthermore, the aforementioned functions may be realized by being combined with a program already recorded in the computer system.

Additionally, the effects described in the present specification are merely explanatory or exemplary, and are not limiting. In other words, the features in the present disclosure may, in addition to the effects mentioned above or instead of the effects mentioned above, have other effects that would be clear to a person skilled in the art from the descriptions in the present specification.

### INDUSTRIAL APPLICABILITY

The present invention can be applied to the generation of a neural network.

### REFERENCE SIGNS LIST

300 Neural network generation device
200 Convolutional neural network (CNN)
100 Neural network execution model (NN execution model
400 Neural network hardware model
500 Software
600 Neural network hardware
1 First memory
2 Second memory
3 DMA contoller (DMAC)
4 Convolution operation circuit
42 Multiplier
43 Accumulator circuit
5 Quantization operation circuit
52 Vector operation circuit
53 Quantization circuit
6 Controller
61 Register
PM Learned parameter
DS Training data set
HW Hardware information
NW Network information

1. A neural network generation device that generates a neural network execution model for performing neural network operations, the neural network generation device comprising:
an execution model generation unit that generates the neural network execution model based on hardware information regarding hardware in which the neural network execution model is running and network information regarding the neural network; and
a software generation unit that generates software for running neural network hardware obtained by installing the neural network model in the hardware.

2. The neural network generation device according to claim 1, wherein:
the software generation unit generates the software for making the neural network hardware perform the neural network operations in a partitioned manner.

3. The neural network generation device according to claim 2, wherein:
the software generation unit generates the software for making the neural network hardware perform the neural network operations with input data to the neural network partitioned into partial tensors.

4. The neural network generation device according to claim 3, wherein:
the software generation unit partitions the neural network based on a consecutive number of convolution operations to be consecutively implemented by the neural network hardware.

5. The neural network generation device according to claim 4, wherein:
the neural network hardware has a memory for storing the partial tensor; and
the software generation unit generates software for performing memory transfer of data necessary for the consecutive convolution operations to the memory from an external memory before implementing the consecutive convolution operations.

6. The neural network generation device according to claim 5, wherein:
the software generation unit determines the consecutive number of the convolution operations to be consecutively implemented based on data amounts in unused areas of the memory.

7. The neural network generation device according to claim 3, wherein:
the neural network hardware has a memory for storing the partial tensors; and
the software generation unit generates software for performing memory transfer of the partial tensors necessary for the operations to the memory from an external memory before implementing the operations if the partial tensors necessary for the operations are not stored in the memory.

8. The neural network generation device according to claim 2, wherein:
the software generation unit allocates the partitioned neural network operations to the neural network hardware.

9. A neural network control method for controlling neural network hardware that performs neural network operations, the neural network control method comprising:
making the neural network hardware perform the operations by partitioning the neural network.

10. The neural network control method according to claim 9, wherein:
the neural network is partitioned by partitioning input data to the neural network into partial tensors.

11. The neural network control method according to claim 10, wherein:
the neural network is partitioned based on a consecutive number of convolution operations to be implemented by the neural network hardware.

12. The neural network control method according to claim 9, wherein:
the partitioned neural network operations are allocated to the neural network hardware.

13. A non-transitory computer-readable recording medium storing the program for generating software to control neural network hardware that performs neural network operations, the software generation program comprising:
making a computer generate the software for making the neural network hardware perform the operations by partitioning the neural network.

14. The non-transitory computer-readable recording medium storing the software generation program according to claim 13, wherein:
the neural network is partitioned by partitioning input data to the neural network into partial tensors.

15. The non-transitory computer-readable recording medium storing the software generation program according to claim 14, wherein:
the neural network is partitioned based on a consecutive number of convolution operations to be implemented by the neural network hardware.

16. The non-transitory computer-readable recording medium storing the software generation program according to claim 13, comprising:
making the computer generate the software by allocating the partitioned neural network operations to the neural network hardware.

17. The neural network generation device according to claim 1, wherein:
the software generation unit generates the software including learned parameters relating to the neural network execution model.

18. The neural network generation device according to claim 17, further having:
a storage unit that stores the learned parameters.

19. The neural network generation device according to claim 1, further having:
a hardware generation unit that generates a hardware model by which the neural network execution model can be installed in the hardware.

20. The non-transitory computer-readable recording medium storing the software generation program according to claim 16, wherein:
the software is generated so as to include learned parameters relating to the neural network.
